(19) United States
(12) Patent Application Publication
(10) Pub. No.: US 2013/0318587 A1
(43) Pub. Date: Nov. 28, 2013

(54) AUTHENTICATION METHOD AND WIRELESS CONNECTION DEVICE

(71) Applicant: BUFFALO INC., Nagoya-shi (JP)

(72) Inventor: Shahriar SHAMSSPOOR, Nagoya-shi (JP)

(73) Assignee: BUFFALO INC., Nagoya-shi (JP)

(21) Appl. No.: 13/899,190

(22) Filed: May 21, 2013

(30) Foreign Application Priority Data
May 24, 2012 (JP) 2012-118843

(51) Int. Cl. H04W 12/06

(52) U.S. Cl. CPC H04W 12/06
USPC 726/7

(57) ABSTRACT

A method of authenticating a client device, the method including: (a) sending information to a client device indicating an image group to be displayed by the client device, wherein the image group includes a plurality of images each assigned to a respective one of a plurality of characters; (b) obtaining, from the client device, a plurality of images selected from the image group displayed by the client device and a specified order of the plurality of selected images; (c) creating a set of characters based on the plurality of selected images, the specified order of the plurality of selected images, and the characters assigned to each of the plurality of selected images; and (d) authenticating the client device based on a determination of whether the created set of characters matches information of a permission candidate stored in advance by the wireless connection device.

### CROSS-REFERENCE TO RELATED APPLICATIONS

This application claims priority to Japanese Patent Application No. 2012-118843 filed on May 24, 2012, which is hereby incorporated by reference in its entirety and for all purposes.

### TECHNICAL FIELD

This disclosure relates to authentication technology of wireless communication.

### BACKGROUND ART

As is known in the art, a password generally provided in the form of a character string is used for authentication that identifies whether each user is an authorized user who is allowed to use the wireless network relay device. A fixed password system is widely applied to authentication using the password, which performs authentication by entry of a predetermined user name and a corresponding password. The fixed password system is simple and is thus widely spread, but there is a possibility that the password is leaked. In the fixed password system, the password is in the readily copyable form as the character string and is often used continuously for a long time without being changed. A malicious third person may use the leaked password for abuse or fraud.

In order to solve such a problem and provide a not-readily-copyable password, one proposed technique uses an array of an unknown total number of images as a key for authentication of the user (for example, JP 2007-094523A).

This proposed technique enables user authentication using the not-easily-copyable password. This technique, however, requires time- and labor-consuming user's operations to set the password and accordingly has the problem of poor convenience.

This problem is not limited to the case where the wireless network relay device authenticates the client device but is commonly found in the case where any device that provides each client device with services via wireless communication authenticates the client device that uses the services.

### SUMMARY

According to one aspect of the invention, there is provided a method of authenticating a client device. The method including: (a) sending information to a client device indicating an image group to be displayed by the client device, wherein the image group includes a plurality of images each assigned to a respective one of a plurality of characters; (b) obtaining, from the client device, a plurality of images selected from the image group displayed by the client device and a specified order of the plurality of selected images; (c) creating a set of characters based on the plurality of selected images, the specified order of the plurality of selected images, and the characters assigned to each of the plurality of selected images; and (d) authenticating the client device based on a determination of whether the created set of characters matches information of a permission candidate stored in advance by the wireless connection device.

The disclosure may be implemented by any of various applications, for example, an authentication method and an authentication device, an authentication method adopted in a wireless network relay device, a wireless network relay device, a wireless network system, a computer program configured to implement the functions of any of these methods and devices, and a non-transitory, computer-readable storage medium in which such a computer program is recorded.

### BRIEF DESCRIPTION OF DRAWINGS

FIG. 1 is a diagram illustrating the general configuration of a network system using a wireless network relay device according to a first embodiment of the disclosure;

FIG. 2 is a diagram illustrating the general configuration of an access point device according to the first embodiment;

FIG. 3 is a diagram illustrating one example of virtual ports of the access point device;

FIG. 4 is a diagram illustrating the general configuration of a client device;

FIG. 5 is a sequence diagram showing the procedure of a wireless communication setup process;

FIG. 6 is a state transition diagram of a phase PH1 and a phase PH2 of the wireless communication setup process;

FIG. 7 is a diagram illustrating the state of exchange of configuration information by encrypted communication;

FIG. 8 is a diagram illustrating one example of a wireless network connection screen provided by the OS of the client device that has received beacon;

FIG. 9 is a diagram illustrating one example of a user name entry screen displayed on the WEB browser of the client device at step S116;

FIG. 10 is a diagram illustrating one example of a configuration application download screen displayed on the WEB browser of the client device at step S134;

FIG. 11 is a diagram illustrating one example of a screen displayed on the client device that has downloaded the configuration application;

FIG. 12 is a diagram illustrating one example of a recommended files list screen displayed on the client device at step S190;

FIG. 13 is a diagram illustrating one example of an ID card used for user authentication according to a first embodiment of an easy authentication process;

FIG. 14 is a sequence diagram showing the procedure of the first embodiment of the easy authentication process;

FIG. 15 is a diagram illustrating one example of a correspondence list created at step S802;

FIG. 16 is a diagram illustrating one example of an authentication screen displayed on the WEB browser of the client device at step S808;

FIG. 17 is a sequence diagram showing the procedure of a second embodiment of the easy authentication process;

FIG. 18 is a diagram illustrating one example of candidates created at step S904;

FIG. 19 is a diagram illustrating one example of an authentication screen displayed on the WEB browser of the client device at step S908;

FIG. 20 is a diagram illustrating one example of an ID card used for user authentication according to a third embodiment of the easy authentication process;

FIG. 21 is a diagram illustrating one example of correspondence lists created at step S802 in the easy authentication process;

FIG. 22 is diagrams illustrating examples of an ID card used for user authentication according to the fourth embodiment of the easy authentication process;

FIG. 23 is a diagram illustrating one example of the authentication screen displayed on the WEB browser of the client device at step S808 in the easy authentication process of FIG. 14; and

FIG. 24 is a sequence diagram showing the procedure of a wireless communication setup process according to a second embodiment.

### DESCRIPTION OF EMBODIMENTS

### A. First Embodiment

### A-1. General Configuration of System

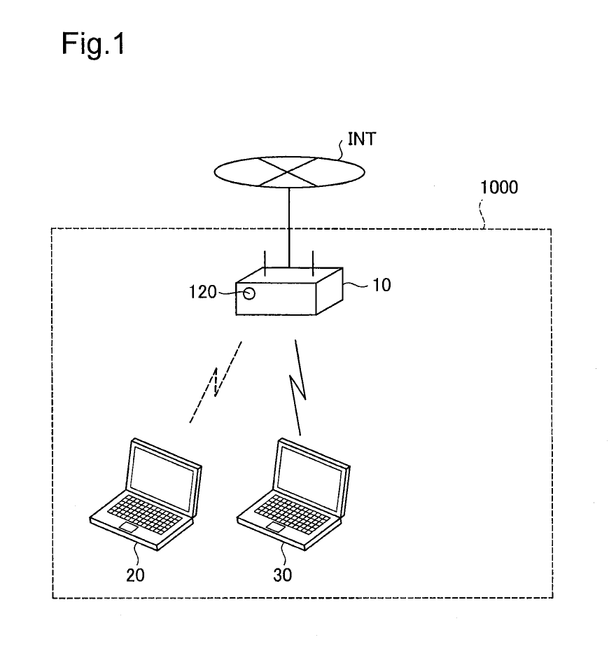

FIG. 1 is a diagram illustrating the general configuration of a network system using a wireless network relay device according to one embodiment of the disclosure. The network system 1000 includes a wireless network relay device 10 provided as a wireless connection device and two client devices 20 and 30. Hereinafter the client device is also simply called “client”.

The wireless network relay device 10 according to this embodiment is an access point device in conformity with IEEE 802.11. Hereinafter the wireless network relay device 10 is also called “AP10”. The AP 10 relays wireless communication to the client devices 20 and 30. According to this embodiment, the AP 10 also serves as a router and is connected to the Internet INT via a wired cable. The AP 10 supports the conventionally known AOSS (AirStation One-Touch Secure System) and WPS (Wi-Fi Protected Setup) as the functions to automatically set wireless communication ID information and encryption information into the client devices. The “wireless communication ID information” is information used to establish wireless communication and may be ID information, such as BSSID (Basic Service Set Identifier), ESSID (Extended Service Set Identifier) or SSID (Service Set Identifier). The “encryption information” includes information representing a wireless LAN encryption system, such as WEP (Wired Equivalent Privacy), WPA (Wi-Fi Protected Access) or WPA2-PSK (Wi-Fi Protected Access 2 Pre-Shared Key) and a key used for encryption.

The AP 10 supports a wireless communication setup process described later. This wireless communication setup process is a process of easily setting the wireless communication ID information and the encryption information into the client device without requiring any portable storage medium, while maintaining the security level of the AP 10. The AP 10 has a set button 120 operated as the trigger to start the wireless communication setup process. The details of the wireless communication setup process will be described later.

The client device 20 according to this embodiment is a personal computer including a wireless communication interface in conformity with IEEE 802.11. Hereinafter the client device 20 is also called “PC 20”. The PC 20 has no settings of the wireless communication ID information and the encryption information and thereby has not yet established communication with the AP 10 in the state of FIG. 1. According to this embodiment, the client device 30 is a personal computer including a wireless communication interface in conformity with IEEE 802.11, like the PC 20. Hereinafter the client device 30 is also called “PC 30”. The PC 30 has the settings of the wireless communication ID information and the encryption information and thereby has established communication with the AP 10 in the state of FIG. 1.

### A-2. General Configuration of Wireless Network Relay Device

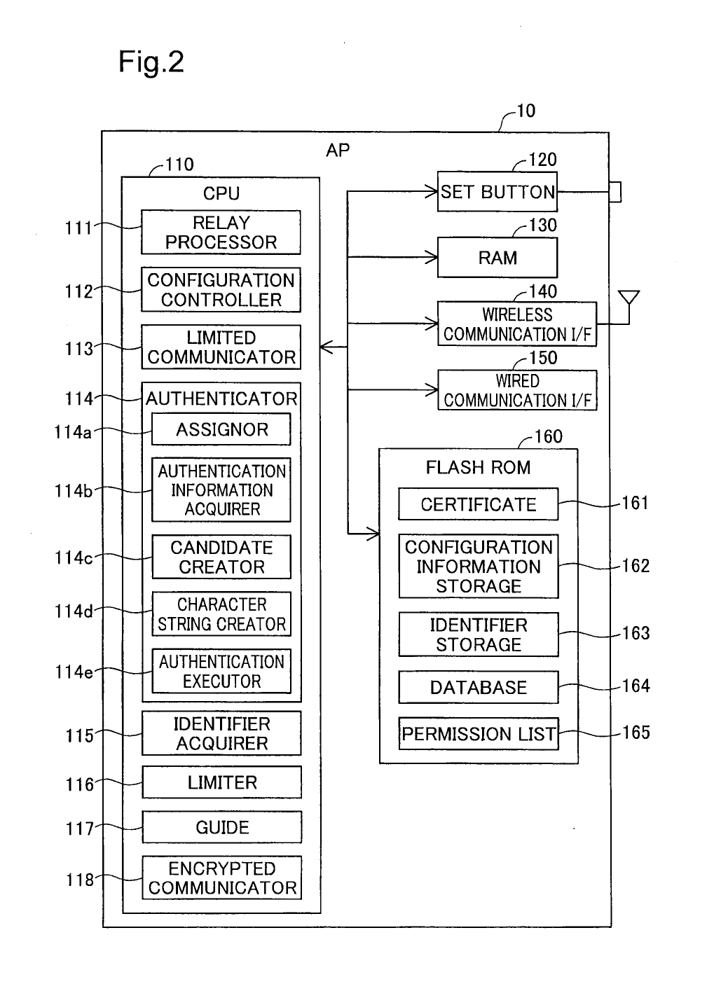

FIG. 2 is a diagram illustrating the general configuration of the AP 10. The AP 10 includes a CPU 110, a set button 120, a RAM 130, a wireless communication interface (I/F) 140, a wired communication interface (UF) 150 and a flash ROM 160, which are interconnected by a bus.

The CPU 110 loads and executes a computer program, which is stored in the flash ROM 160, on the RAM 130 to control the respective parts in the AP 10. The CPU 110 implements the functions of a relay processor 111, a configuration controller 112, a limited communicator 113, an authenticator 114, an identifier acquirer 115, a limiter 116, a guide 117 and an encrypted communicator 118.

The relay processor 111 performs a relay process that forwards a received packet according to a destination. The configuration controller 112 controls the entire wireless communication setup process. The limited communicator 113 establishes temporary communication in the wireless communication setup process. The authenticator 114 performs an easy authentication process performed as a subroutine of the wireless communication setup process. The AP 10 authenticates each client based on an image or a character string according to the easy authentication process. The authenticator 114 includes an assignor 114a, an authentication information acquirer 114b, a candidate creator 114c, a character string creator 114d and an authentication executor 114e. The details will be described later. The identifier acquirer 115 obtains a MAC address of each client as an identifier assigned to the client. The limiter 116 limits communication in the wireless communication setup process. The guide 117 generates information used by the client device to display a guide screen and sends the generated information to the client device. The encrypted communicator 118 establishes encrypted communication in conformity with a specified encryption system between the AP 10 and the other end of communication.

The set button 120 is a momentary switch provided in the casing of the AP 10, and the wireless communication setup process is triggered by detection of a press of the set button 120. The set button 120 is preferably actualized by a switch that is not kept in the pressed state.

The wireless communication interface 140 includes a transmitting and receiving circuit (not shown) and has the function of demodulating radio waves received via an antenna and generating data and the function of generating and modulating radio waves that are to be transmitted via the antenna. The wired communication interface 150 is connected with a line of the Internet IN and is connected with a device on the other end of communication via a wired cable. The wired communication interface 150 includes a PHY/MAC (PHYsical layer/Medium Access Control layer) controller (not shown) and has the function of wave-shaping a received signal and the function of extracting a MAC frame from the received signal.

The flash ROM 160 includes a certificate 161, a configuration information storage 162, an identifier storage 163, a database 164, and a permission list 165. The certificate 161 is an SSL server certificate used in the wireless communication setup process. The configuration information storage 162 includes the wireless communication ID information and the encryption information. The identifier storage 163 is a storage for storing the identifier of each client obtained by the identifier acquirer 115.

The database 164 stores images and character strings used in the easy authentication process. The permission list 165 is information used to authenticate each client device as an authorized client device in the easy authentication process. The permission list 165 stores a PIN (Personal Identification Number) of the AP 10 that is a character string representing a security code used to identify each user as an authorized user of the AP 10. The permission list 165 may store a plurality of PINs.

The AP 10 of the embodiment supports the multi SSID function. The AP 10 thus enables one physical access point device to operate as a plurality of virtual access points that are a plurality of logical access points. The AP 10 sets a different SSID for each virtual access point and thereby independently controls the connection with the virtual access point. Hereinafter the virtual access point is also called “virtual port”.

The connection object to the AP 10 is limited to any client device that is informed of an SSID (or ESSID or BS SID) set at a virtual port of the AP 10, in other words, any client device that has the setting of an SSID identical with the SSID set for the virtual port of the AP 10. As another method for security enhancement, the relay processor 111 of the AP 10 may adopt the method of encrypting an SSID included in a beacon or the method of requesting each client device for authentication information in the course of connection of the client device with the AP 10.

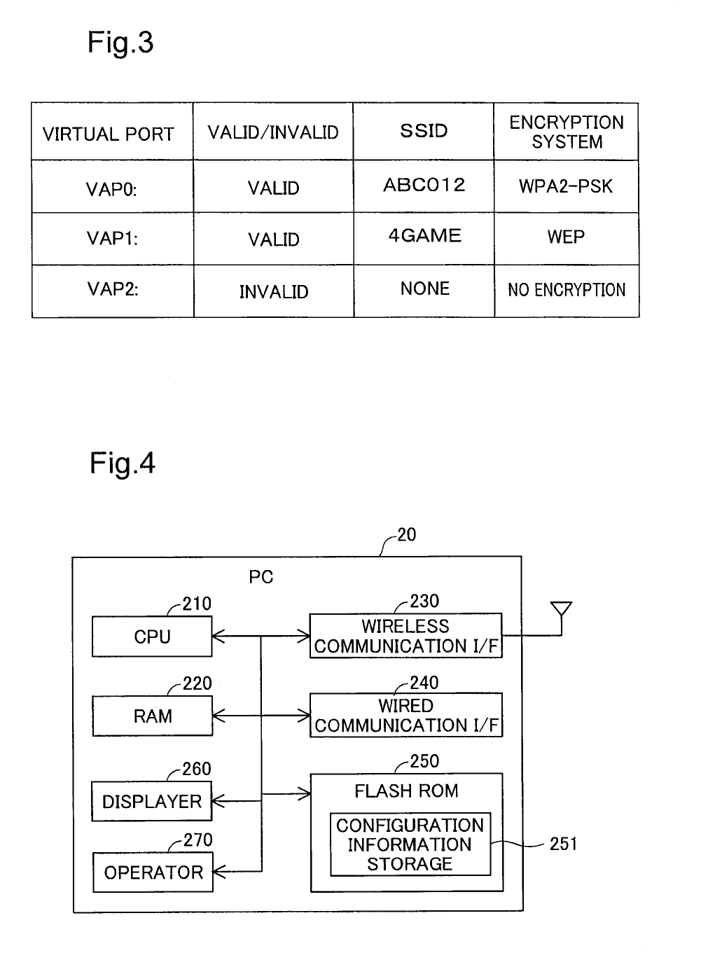

FIG. 3 is a diagram illustrating one example of the virtual ports of the AP 10. The AP 10 of this embodiment has three virtual ports VAP0 to VAP2. The validity/invalidity of SSID setting, an SSID and the communication encryption system are set for each port. For example, the validity of an SSID “ABC012” and the use of WPA2-PSK as the communication encryption system are set for a virtual port VAP0. The validity of an SSID “4GAME” and the use of WEP as the communication encryption system are set for a virtual port VAP1. The virtual port VAP1 is used for communication by WDS (Wireless Distribution System). The invalidity of SSID setting and no use of the encrypted communication are set for a virtual port VAP2.

### A-3. General Configuration of Client

FIG. 4 is a diagram illustrating the general configuration of the PC 20. The PC 20 as the client device includes a CPU 210, a RAM 220, a wireless communication interface (I/F) 230, a wired communication interface (I/F) 240, a flash ROM 250, a displayer 260 and an operator 270, which are interconnected by a bus.

The CPU 210 loads and executes a computer program, which is stored in the flash ROM 250 or in a hard disk drive (not shown), on the RAM 220 to control the respective parts in the PC 20. The wireless communication interface 230 includes a transmitting and receiving circuit (not shown) and has the function of demodulating radio waves received via an antenna and generating data and the function of generating and modulating radio waves that are to be transmitted via the antenna. The wired communication interface 240 is connected with a device on the other end of communication via a wired cable. The flash ROM 250 includes the computer program (not shown) for controlling the PC 20 and a configuration information storage 251. The configuration information storage 251 is a storage for storing the configuration information (wireless communication ID information and encryption information) obtained by the wireless communication setup process described below. The displayer 260 includes a display (not shown) and a displayer driver and has the function of providing a visual screen display to the user. The operator 270 includes a mouse and a keyboard (not shown) and their drivers and the function of receiving the user's entries.

### A-4. Wireless Communication Setup Process

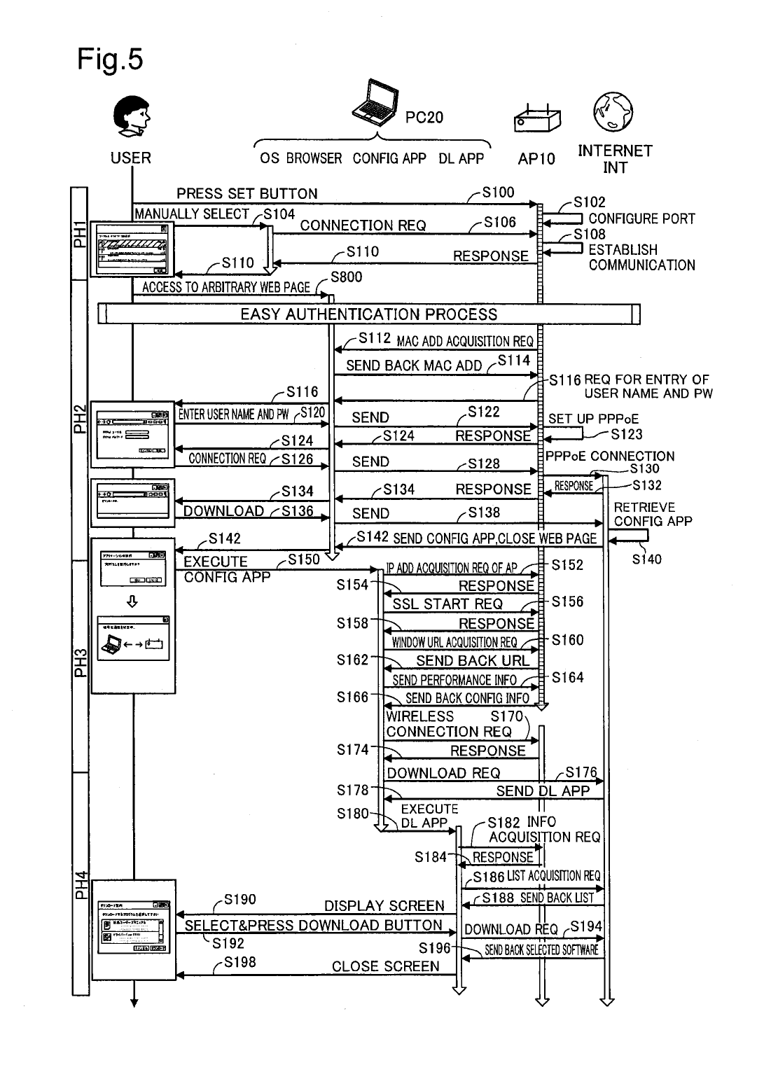

FIG. 5 is a sequence diagram showing the procedure of the wireless communication setup process. The wireless communication setup process is a process of easily setting the configuration information (wireless communication ID information and encryption information) in a client without requiring any portable storage medium, while avoiding reduction of the security level in the AP 10. The wireless communication setup process includes four main phases PH1 to PH4. The phase PH4 may be omitted according to the requirements.

PH1: phase of establishing temporary communication between AP and client device;

PH2: phase of controlling AP to authenticate client device and controlling client device to receive configuration application;

PH3: phase of establishing encrypted communication between AP and client device; and

PH4: phase of causing client device to obtain recommended files.

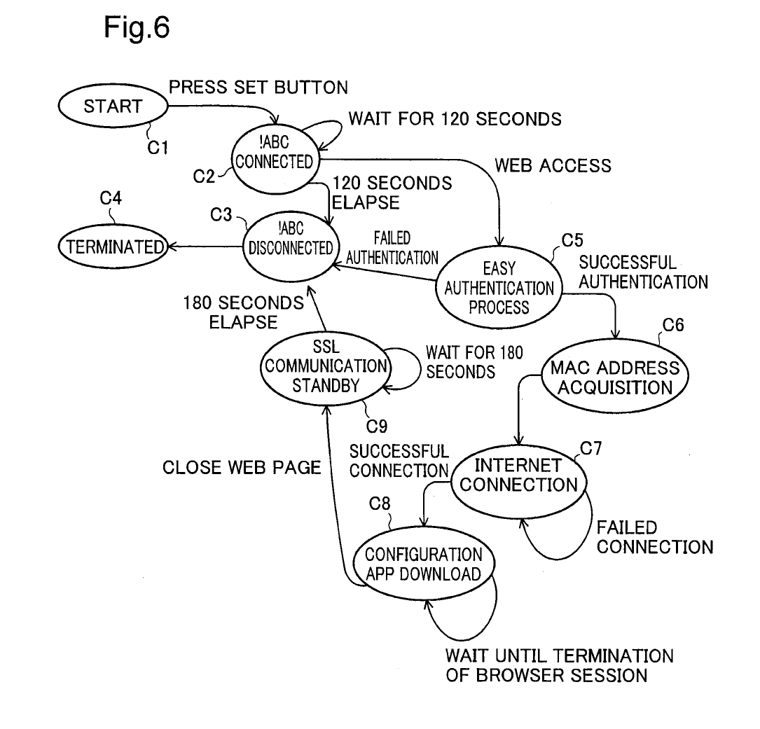

FIG. 6 is a state transition diagram showing states C1 to C9 in the phase PH1 and the phase PH2 of the wireless communication setup process. The following describes the wireless communication setup process with reference to FIG. 6 in combination with the sequence diagram of FIG. 5. In the following description, the PC 20 is set as an example of the client device.

A-4-1. Phase PH 1 (Phase of Establishing Temporary Communication Between AP and Client Device)

The user presses the set button 120 of the AP 10 (step S100). The AP 10 detects a press of the set button 120 and configures a virtual port for establishing temporary communication between the PC 20 and the AP 10 (step S102). More specifically, the configuration controller 112 of the AP 10 switches the validity of SSID setting of the virtual port VAP2 (FIG. 3) from invalid to valid and changes the value of an SSID to “!ABC”. The changed SSID is included in a beacon that is sent by the AP 10 and is notified to the PC 20. Even when the PC 20 is not notified of the SSID “!ABC” in advance, the PC 20 receives the beacon and recognizes the presence of the AP 10 with the SSID “!ABC”. The wireless communication setup process may be triggered by another operation (for example, detection of a start instruction provided in the form of short-range communication to the AP 10), instead of by a press of the set button.

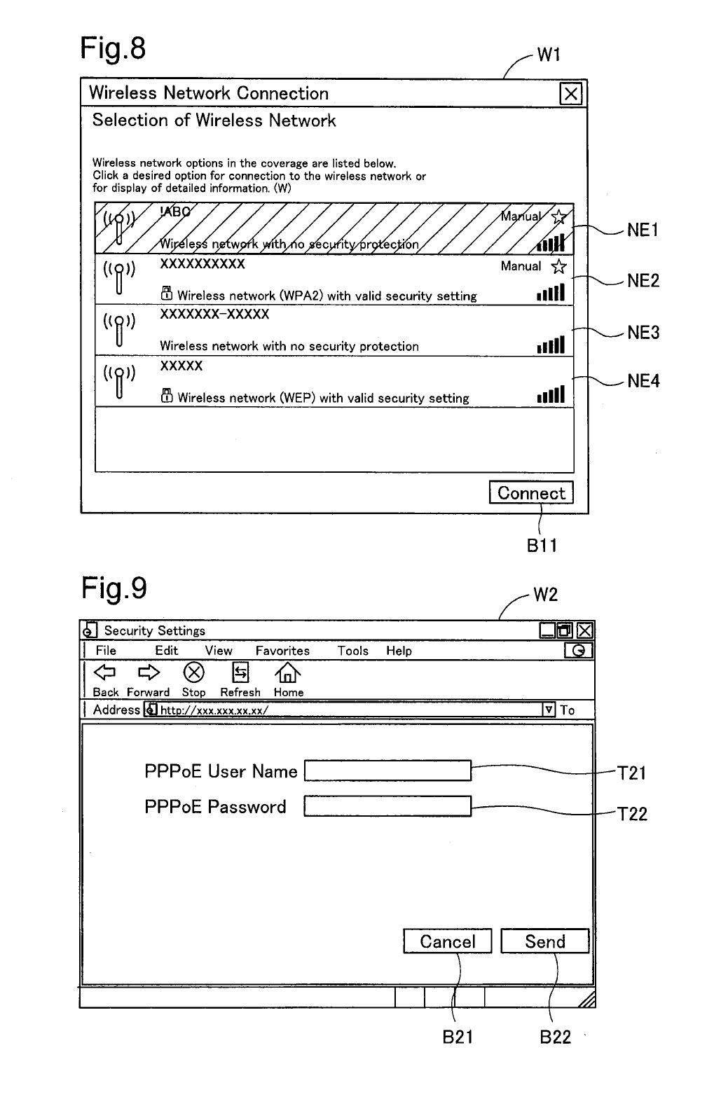

FIG. 8 illustrates one example of a wireless network connection screen provided by the operating system of the PC 20 that has received the beacon. Hereinafter the operating system is called “OS”. A wireless network connection screen W1 includes the display of a list of information NE1 to NE4 on a plurality of physical access points or virtual access points, from which the PC 20 has received beacons, and the display of a Connect button B11. A preferable method of displaying the information on the wireless network connection screen W1 is an ascending order of SSID (the SSID of the smallest character code is displayed on the top). Changing the SSID to “!ABC” at step S102 enables the virtual port VAP2 of the AP 10 to be displayed on the top or near the top in the list on the wireless network connection screen W1. This enables the user to readily find the AP 10 on the displayed list, thus enhancing the user's convenience.

The user manually selects the AP 10 with the SSID “!ABC” on the wireless network connection screen W1 and presses the Connect button B11 (step S104). In response to the press of the Connect button B11, a module for wireless LAN connection provided by the OS of the PC 20 sends a connection request with specification of the selected SSID “!ABC” to the AP 10 (step S106). When the AP 10 receives the connection request from the PC 20, the limited communicator 113 of the AP 10 establishes non-limited, temporary communication between the PC 20 and the AP 10, based on communication settings specified in advance for the virtual port VAP2 identified by the SSID “!ABC” (i.e., communication settings without encryption) (step S108). Hereinafter wireless connection using the SSID “!ABC” is called “!ABC connection”. After establishment of temporary communication, the limited communicator 113 sends a response representing establishment of communication to the PC 20 (step S110). The state of the wireless communication setup process (FIG. 6) then shifts from start state C1 to !ABC connected state C2.

A-4-2. Phase PH2 (Phase of Controlling AP to Authenticate Client Device and Controlling Client Device to Receive Configuration Application)

In response to the user's access from the PC 20 to an arbitrary WEB page (step S800 in FIG. 5) as the trigger, the authentication executor 114e of the AP 10 performs the easy authentication process to authenticate the PC 20. The details of the easy authentication process will be described later in “A-5. Easy Authentication Process”. The easy authentication process may be omitted according to the requirements. The state of the wireless communication setup process (FIG. 6) then shifts from the !ABC connected state C2 to easy authentication process state C5. When the AP 10 has not received an access request to any WEB page from the PC 20 for a predetermined time (for example, 120 seconds) in the !ABC connected state C2, on the other hand, the limited communicator 113 terminates the temporary communication with the SSID “!ABC”. The state of the wireless communication setup process then shifts to terminated state C4 via !ABC disconnected state C3.

When the result of the easy authentication process shows failed authentication, the limited communicator 113 terminates the temporary communication with the SSID “!ABC”. The state of the wireless communication setup process (FIG. 6) then shifts to the terminated state C4 via the !ABC disconnected state C3. This step may be omitted according to the requirements.

When the result of the easy authentication process shows successful authentication, on the other hand, the identifier acquirer 115 of the AP 10 sends a MAC address acquisition request to the PC 20 (step S112). When receiving the MAC address acquisition request, the PC 20 sends back its own MAC address to the AP 10 (step S114). The identifier acquirer 115 subsequently stores the received MAC address into the identifier storage 163. The state of the wireless communication setup process (FIG. 6) then shifts from the easy authentication process state C5 to MAC address acquisition state C6.

The MAC address acquisition state C6 may adopt any other means that enables the MAC address of the PC 20 to be obtained. For example, when the result of the easy authentication process shows successful authentication, the identifier acquirer 115 may store a source MAC address included in the header of a packet received from the PC 20 at step S812 in FIG. 14 described later. This modification allows omission of steps S112 and S114. The MAC address acquisition state C6 obtains the MAC address of the PC 20. The MAC address is, however, not restrictive and may be replaced by any other identifier assigned to the client, for example, an ID assigned in advance like a production serial number.

After the AP 10 receives the MAC address from the PC 20, the limiter 116 of the AP 10 uses the obtained MAC address to limit subsequent communication by the !ABC connection. More specifically, the limiter 116 refers to the header of a received packet and compares a source MAC address included in the header with the MAC address stored in the identifier storage 163. The limiter 116 allows transmission of the packet with matching MAC address, while discards the packet with mismatching MAC address. This process is called “filtering process”. This process limits the communication by the !ABC connection to the client successfully authenticated as valid in the easy authentication process, thus enhancing the security (confidentiality) of the wireless communication setup process.

The guide 117 of the AP 10 generates information for displaying a guide screen that requests the user to enter a user name and a password for PPPoE (PPP over Ethernet) on the WEB browser and sends the generated information to the PC 20 (step S116). Instead that the guide 117 requests the user to enter the user name and the password for PPPoE, the AP 10 may automatically try a PPPoE connection using default settings of the user name and the password stored in the AP 10.

FIG. 9 illustrates one example of a user name entry screen displayed on the WEB browser of the PC 20 at step S116. A user name entry screen W2 includes a text box T21 for entering a PPPoE user name, a text box T22 for entering a PPPoE password, a Cancel button B21 and a Send button B22. The user respectively enters a specified PPPoE user name in the text box T21 and a specified PPPoE password in the text box T22 and presses the Send button B22 (step S120). In response to the press of the Send button B22, the entries of the PPPoE user name and the PPPoE passwords are sent to the AP 10 (step S122).

When the AP 10 receives the PPPoE user name and the PPPoE password, the configuration controller 112 of the AP 10 uses the obtained user name and password to set up PPPoE (step S123). After the setup, the guide 117 generates information for displaying completion of PPPoE settings and a guide screen requesting the user to give a connection instruction on the WEB browser and sends the generated information to the PC 20 (step S124). When the user provides a connection instruction according to a message displayed on the WEB browser to request the user to give a connection instruction, a PPPoE connection request is sent to the AP 10 (steps S126, S128). When the AP 10 receives the PPPoE connection request, the configuration controller 112 of the AP 10 establishes PPPoE connection according to the detailed settings (step S130). The state of the wireless communication setup process (FIG. 6) then shifts from the MAC address acquisition state C6 to Internet connection state C7. In the case of failed connection, the Internet connection state C7 retries the PPPoE connection for a predetermined time or a predetermined number of times.

After the attempt for PPPoE connection, the guide 117 generates information for displaying the result of the PPPoE connection (step S132) and a guide screen requesting the user to download a configuration application on the WEB browser and sends the generated information to the PC 20 (step S134). In the drawings, the configuration application is expressed as “configuration app”.

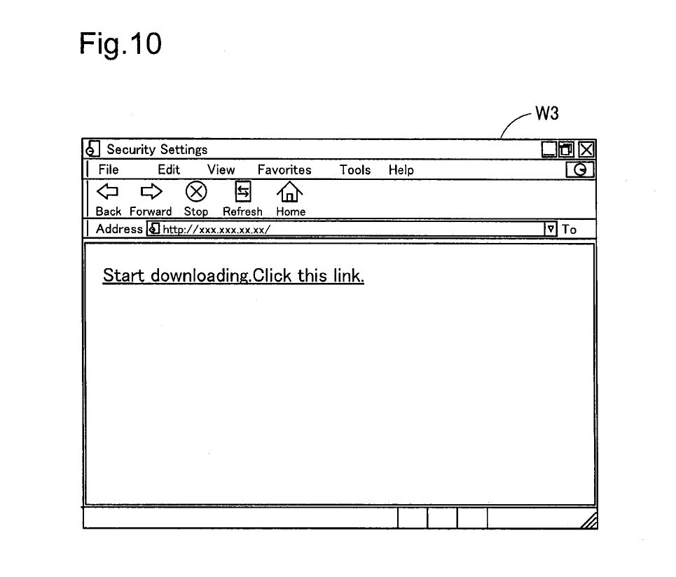

FIG. 10 illustrates one example of a configuration application download screen displayed on the WEB browser of the PC 20 at step S134. A configuration application download screen W3 has a link to request a start of downloading. The link displays a message representing a request to start downloading and is arranged to be clicked to send a download request to a specified server on the Internet. The user clicks the link according to the message displayed as the link (step S136). The click of the link sends the download request to the specified server on the Internet (step S138).

When receiving the download request, the PC 20 retrieves a configuration application suitable for the PC 20 from a storage (not shown) (step S140). For example, when the download request includes the model of the PC 20 and the type and the version of the OS installed in the PC 20, the server may retrieve a specifically created configuration application, based on such information. The server then sends the retrieved configuration application to the PC 20 and closes the WEB page of the PC 20 (step S142). The state of the wireless communication setup process (FIG. 6) then shifts from Internet connection state C7 to configuration application download state C8. The configuration application download state C8 stands by until the WEB page is closed by the server or until session timeout of the WEB browser. When the WEB page is closed by the server, the state of the wireless communication setup process shifts to SSL communication standby state C9 and, after waiting for a predetermined time (for example, 180 seconds), subsequently shifts to the terminated state C4 via the !ABC disconnected state C3.

The configuration application downloaded state C8 causes the AP 10 to download the configuration application from the specified server on the Internet but may adopt a modified arrangement without using any server on the Internet for such downloading. For example, the configuration application may be stored in the flash ROM 160 of the AP 10 or in an external storage device (not shown) (for example, USB hard disk drive) connected with the AP 10. The modified arrangement may send a download request to the AP 10, in response to the user's click of the link on the configuration application download screen W3. This modified arrangement enables the configuration application to be downloaded without using any server on the Internet.

A-4-3. PH3 (Phase of Establishing Encrypted Communication Between AP and Client Device)

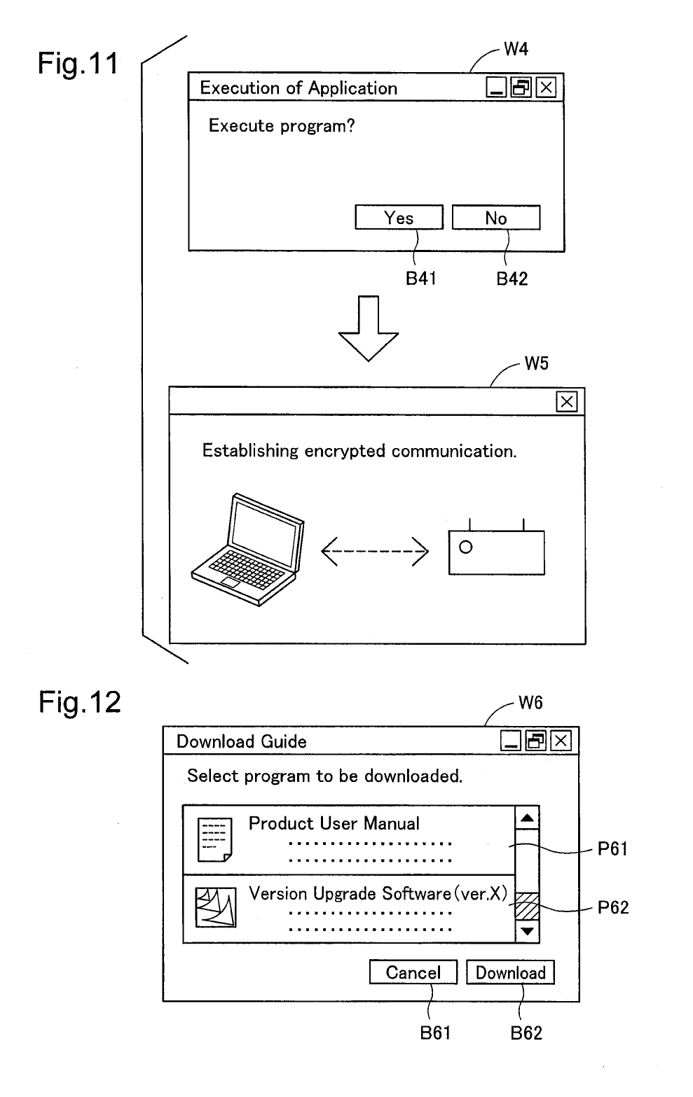

FIG. 11 illustrates one example of a screen displayed on the PC 20 that has downloaded the configuration application. On the PC 20 that has downloaded the configuration application, an execution confirmation screen W4 shown on the upper half of FIG. 11 is displayed first by the OS. The execution confirmation screen W4 includes a message to confirm whether the program is to be executed, a Yes button B41 and a No button B42. When the user presses the Yes button B41, the PC 20 executes the configuration application (step S150). The execution of the configuration application displays a standby screen W5 shown on the lower half of FIG. 11. The standby screen W5 includes a message showing that encrypted communication is being established.

The configuration application of the PC 20 sends an IP address acquisition request to the AP 10 (step S152). When the AP 10 receives the IP address acquisition request, the configuration controller 112 of the AP 10 sends its own IP address (step S154). Any other means that allows the PC 20 to obtain the IP address of the AP 10 may replace the processing of steps S152 and S154. For example, the processing of steps S152 and S154 may be omitted in the arrangement that the PC 20 obtains the IP address included in the header of a packet received from the AP 10.

The configuration application of the PC 20 obtains the IP address of the AP 10 and sends an SSL handshake start request to the AP 10 (step S156). The SSL handshake start request includes an SSL version number, encryption settings and session-specific data of the PC 20. When the AP 10 receives the SSL handshake start request, the encryption communicator 118 of the AP 10 sends a response to the PC 20 (step S158). The response includes an SSL version number, encryption settings, session-specific data of the AP 10 and the certificate 161 of the AP 10 stored in the flash ROM 160. When receiving the response from the AP 10, the configuration application of the PC 20 uses the information included in the response to authenticate the AP 10. This enables establishment of encrypted communication in conformity with the SSL protocol between the AP 10 and the PC 20.

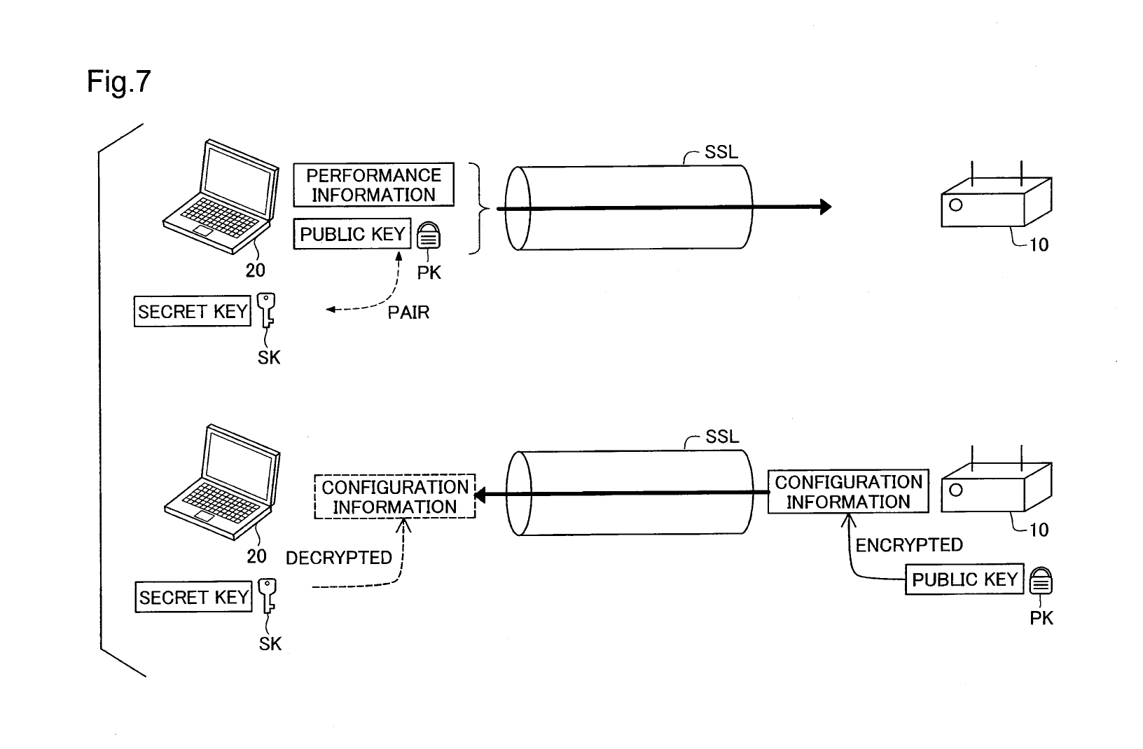

FIG. 7 is a diagram illustrating the state of exchange of configuration information by encrypted communication. After establishment of encrypted communication, the configuration application sends an acquisition request for window URL of the AP 10 for exchange of configuration information (step S160). When the AP 10 receives the window URL acquisition request, the encryption communicator 118 of the AP 10 sends a window URL to the PC 20 (step S162). The configuration application sends performance information of the PC 20 and a generated public key PK to the received window URL of the AP 10 by SSL communication (step S164). The upper half of FIG. 7 shows this state. The performance information includes information representing a wireless use level of the PC 20 (for example, the model name of the wireless communication interface 230 and the encryption system supported by the wireless communication interface 230).

When the AP 10 receives the performance information of the PC 20, the encryption communicator 118 of the AP 10 sends configuration information (wireless communication ID information and encryption information), which is selected from the configuration information in the configuration information storage 162 of the flash ROM 160 based on the received performance information of the PC 20, to the PC 20 (step S166). Before sending the configuration information, the encryption communicator 118 encrypts the configuration information with the public key PK received at step S164 as shown in the lower half of FIG. 7. This causes the configuration information sent from the AP 10 to be encrypted with the public key PK, which is paired with a secret key SK held by only the PC 20 and thereby prevents any third person other than the PC 20 from decrypting the configuration information even when intercepting the configuration information. The configuration information requiring high confidentiality can thus be doubly protected by the protection with the public key/secret key and by the protection of SSL communication.

After receiving the configuration information, the PC 20 sends a connection request to the AP 10 by using the wireless communication ID information and the encryption information included in the configuration information (step S170). When receiving the connection request, the AP 10 establishes encrypted communication, based on the specified wireless communication ID information and encryption information (step S174). More specifically, when the wireless communication ID information received from the PC 20 is the SSID assigned to the virtual port VAP0 (FIG. 3) and when the encryption information includes a key of WPA2-PSK, the AP 10 establishes WPS2-PSK encrypted communication using the virtual port VAP0.

A-4-4. PH4 (Phase of Causing Client Device to Obtain Recommended Files)

On establishment of the encrypted communication, the configuration application sends a download request for application of downloading recommended files to a specified server on the Internet (step S176). Hereinafter the application of downloading recommended files is also called “DL application”. In the drawings, the DL application is expressed as “DL app”. When receiving the download request for DL application, the server retrieves the DL application suitable for the PC 20 from a storage (not shown) and sends the retrieved DL application to the PC 20 (step S178). The detailed procedure is similar to that of retrieving the configuration application described above. When receiving the retrieved DL application, the configuration application executes the DL application and terminates the processing (step S180).

The DL application sends an acquisition request for the information of the AP 10 to the AP 10 (step S182). When receiving the acquisition request, the AP 10 sends back information relating to the AP 10 itself, for example, the model name of the AP 10, the status of the AP 10 and the encryption system supportable by the AP 10 (step S184). When receiving the information on the AP 10, the DL application obtains a list of recommended files from a specified server on the Internet (step S186). More specifically, the DL application sends a guide request of recommended files, which includes the information on the AP 10 and information on the PC 20 (the model of the PC 20 and the type and the version of the OS installed in the PC 20), to the server. The server retrieves recommended files for the PC 20 from a storage (not shown) using the received information on the AP 10 and information on the PC 20 and sends back a list of the retrieved recommended files to the PC 20 (step S188).

The “recommended files” represent programs encouraged to download to or install in the PC 20 when the PC 20 uses the AP 10. The recommended files include, for example, a user manual of the AP 10, assistance software for improvement of the convenience of the AP 10 and software for version upgrade of the AP 10.

The DL application then displays a guide screen to show the list of recommended files (step S190).

FIG. 12 illustrates one example of a recommended files list screen displayed on the PC 20 at step S190. The recommended files list screen W6 includes a list display of information P61 and P62 on recommended files, a Cancel button B61 and a Download button B62. The user selects a desired program for downloading and presses the Download button B62 on the recommended files list screen W6 (step S192). In response to the press of the Download button B62, the DL application sends a download request for the selected program to the server (step S194). When receiving the download request, the server reads out the selected program from a storage (not shown) and sends back the program to the PC 20 (step S196). The DL application repeats the processing of steps S192 to S196 until the user presses the Cancel button B61 and closes the recommended files list screen W6 (step S198).

As described above, according to the wireless communication setup process of the first embodiment, the AP 10 (wireless connection device) establishes the non-limited, temporary communication (!ABC connection) between the PC 20 (client device) and the AP 10. The AP 10 obtains the identifier of the PC 20 or the identifier assigned to the connection between the PC 20 and the AP 10 (MAC address of the PC 20 according to the first embodiment) by the !ABC connection, limits the other end of communication by the !ABC connection with using the obtained identifier and causes the PC 20 to receive the configuration application (file). This enables distribution of the configuration application to the PC 20, while improving the security of the !ABC connection. After termination of the !ABC connection, the AP 10 subsequently establishes encrypted communication in conformity with a predetermined protocol, i.e., SSL, between the AP 10 and the PC 20 that executes the configuration application, and exchanges the performance information and the configuration information (information regarding communication settings) by the encrypted communication. This allows exchange of the performance information and the configuration information by the encrypted communication of high confidentiality. As a result, this enables the communication settings for wireless communication between the PC 20 and the AP 10 to be readily configured without requiring the PC 20 to obtain information required for settings from any portable storage medium, while preventing reduction of the security level of the AP 10.

According to the wireless communication setup process of the embodiment, establishment of the !ABC connection (temporary communication) between the AP 10 and the PC 20 is triggered by the direct touch of the user of the PC 20, for example, the user's press of the Set button 120 of the AP 10, or by detection of a start instruction given to the AP 10 in the form of near field communication. This effectively prevents any malicious third person from giving a start instruction against the user's intention.

According to the wireless communication setup process of the embodiment, the AP 10 uses the !ABC connection (temporary communication) established between the PC 20 and the AP 10 to authenticate the PC 20. This enables the AP 10 to authenticate the PC 20 by using the !ABC connection of the low security level that is easily accessible from the PC 20.

According to the wireless communication setup process of the embodiment, the AP 10 disconnects the !ABC connection (temporary communication) established between the PC 20 and the AP 10 on the occasion of failed authentication of the PC 20, in order to prohibit continuation of the subsequent processing. This prevents the performance information and the configuration information (information regarding communication settings) from being leaked by brute-force attach from any malicious third person.

According to the wireless communication setup process of the embodiment, the PC 20 obtains the information on the AP 10, for example, the model name of the AP 10, the status of the AP 10 and the encryption system supportable by the AP 10, and uses the obtained information on the AP 10 to subsequently obtain the list of recommended files encouraged to download to the PC 20 when the PC 20 uses the AP 10. This enables both the communication settings and the guide of recommended files, thus improving the user's convenience.

### A-5. Easy Authentication Process

The following describes the easy authentication process performed as a subroutine of the wireless communication setup process.

### A-5-1. First Embodiment of Easy Authentication Process

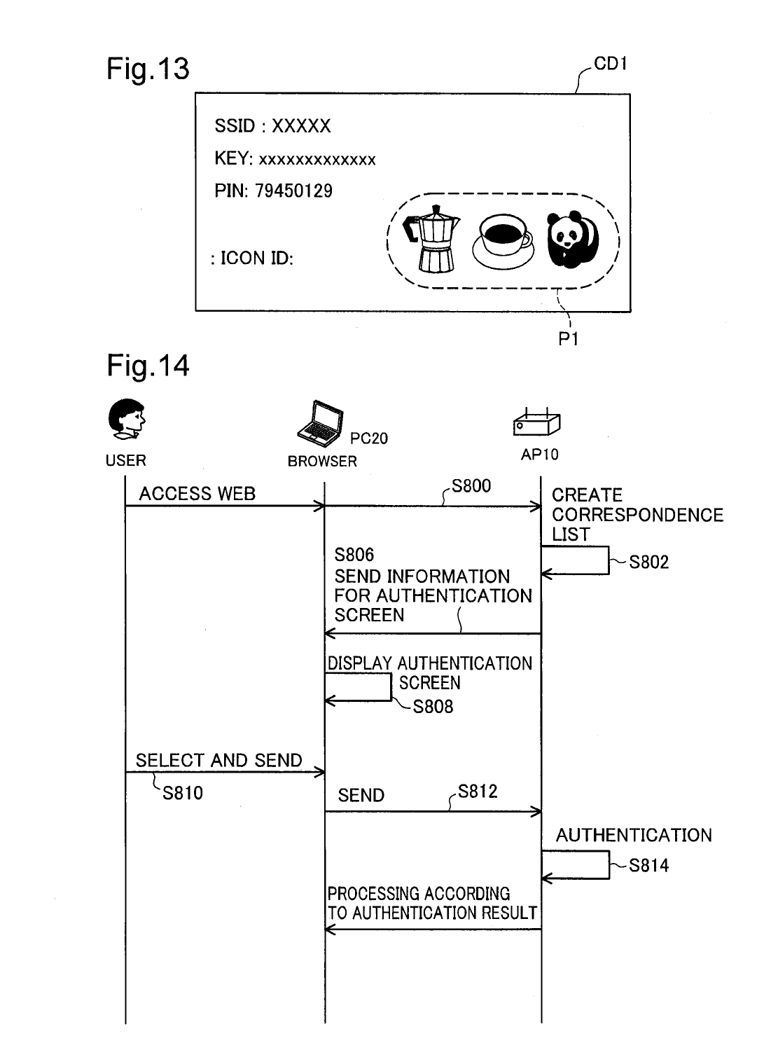

FIG. 13 is a diagram illustrating one example of an ID card used for user authentication according to a first embodiment of the easy authentication process. The ID card CD1 is supplied with the product package of the AP 10 to be distributed in advance to the user of the AP 10. The ID card CD1 includes an SSID field, a KEY field, a PIN field and an ICON ID field.

The SSID field includes a printed character string representing an SSID set as default in the AP 10. The KEY field includes a printed character string representing an encryption key used in the encryption system set as default in the AP 10. The PIN field includes a printed character string representing a security code used to authenticate the user as an authorized user of the AP 10. The ICON ID field includes an image P1 used in the easy authentication process. The image P1 includes a plurality of images printed in an interlinked manner. In the illustrated example of FIG. 13, the images of an espresso maker, a coffee cup and a panda are displayed to be next to one another horizontally.

FIG. 14 is a sequence diagram showing the procedure of the first embodiment of the easy authentication process. The easy authentication process is triggered by the user's access to an arbitrary WEB page at step S800 in the wireless communication setup process (FIG. 5). The assignor 114a of the AP 10 creates a correspondence list (step S802).

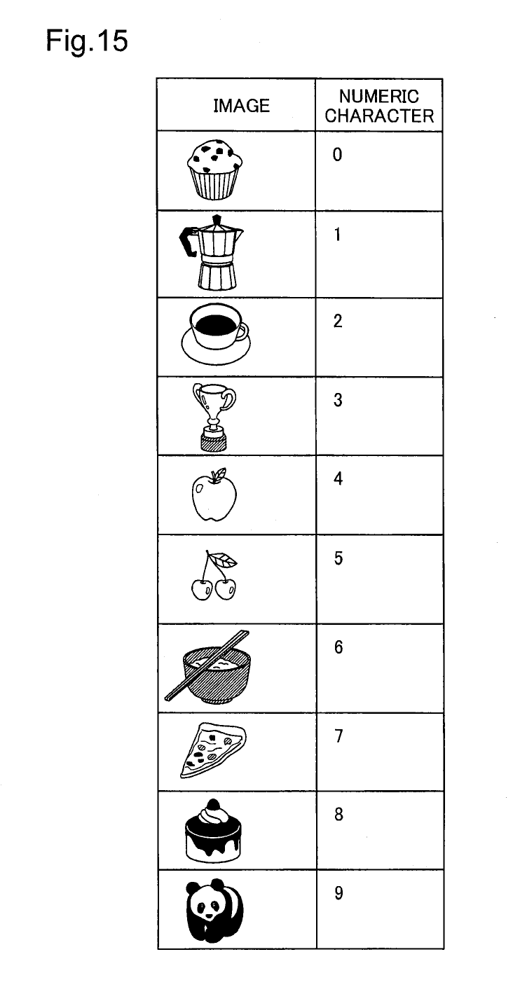

FIG. 15 is a diagram illustrating one example of the correspondence list created at step S802. The correspondence list is a table where each image is assigned to each numeric character by one-to-one correspondence relation. The following describes a method of creating the correspondence list. The assignor 114a (FIG. 5) assigns the same images as the images printed in the ICON ID field of the ID card CD1 to a predetermined digit number of characters (for example, numeric characters in the lower three digits of the PIN) stored in the permission list 165 (FIG. 2). The assignor 114a then assigns seven images selected at random from the database 164 of the flash ROM 160 to the remaining seven numeric characters. The assignment may be performed according to a specific rule or may be performed at random. The assignment should, however, prevent a plurality of different numeric characters from being assigned to one identical image.

At step S802, the assignor 114a assigns the numeric characters and the images selected from the database 164. The processing of step S802 may be modified in various ways to assign a predetermined number of characters and images in the database 164 by one-to-one correspondence. For example, sixteen images may be assigned to numeric characters of “0” to “9” and alphabetic characters of “A” to “F”.

The guide 117 of the AP 10 generates information for displaying an authentication screen on the WEB browser and sends the generated information to the PC 20 (step S806). According to the embodiment, the information for displaying the authentication screen includes images in the correspondence list. For example, when the correspondence list shown in FIG. 15 is created, the information for displaying the authentication screen includes information on the “images of a cupcake, an espresso maker, a coffee cup, . . . , and a panda”. It is preferable that the guide 117 encrypts the information for displaying the authentication screen and sends the encrypted information, in order to prevent interception from any malicious third person. The WEB browser of the PC 20 receives the information for displaying the authentication screen and displays the authentication screen (step S808).

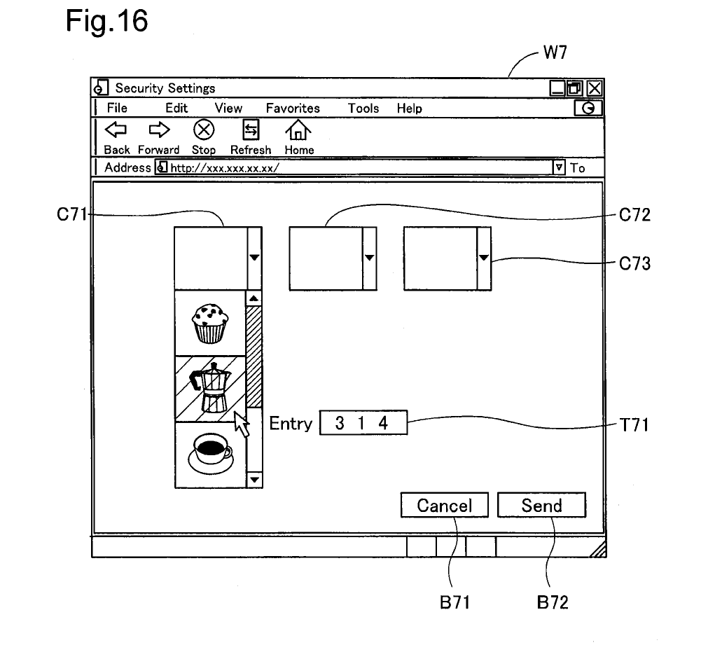

FIG. 16 illustrates one example of the authentication screen displayed on the WEB browser of the PC 20 at step S808. The authentication screen W7 includes three image selection boxes C71, C72 and C73, a text box T71 for entry of a character string, a Cancel button B71 and a Send button B72. The user's press of an arrow icon in the image selection box C71 opens an image group consisting of all the images in the correspondence list (FIG. 15) created at step S802. The same applies for the other image selection boxes C72 and C73.

The user selects the images that are identical with the plurality of images included in the image P1 printed in the ICON ID field of the ID card CD1, in the printing order of the image P1 in the three image selection boxes C71, C72 and C73 and presses the Send button B72 (step S810). For example, when the ID card shown in FIG. 13 is distributed to the user, the user selects the image of an espresso maker in the image selection box C71, the image of a coffee cup in the image selection box C72 and the image of a panda in the image selection box C73 and presses the Send button B72.

In response to the press of the Send button B72, the WEB browser of the PC 20 sends the images selected in the three image selection boxes in the order of C71→C72→C73 to the AP 10, and the authentication information acquirer 114b of the AP 10 obtains these images (step S812). In the illustrated example of FIG. 13, the information sent from the WEB browser includes the “images of an espresso maker, a coffee cup and a panda”.

The authentication executor 114e of the AP 10 performs authentication with the obtained images (step S814). The authentication is performed according to the following steps (1) to (3):

Step (1): The character string creator 114d sorts the obtained images in the order of acquisition. This step may be omitted since the sorted images are sent according to this embodiment.

Step (2): The character string creator 114d creates a set of characters based on the sorted images and the correspondence list. More specifically, the character string creator 114d extracts the numeric characters assigned to the images in the correspondence list and replaces the images with the numeric characters to create the “set of characters” as a string of numeric characters.

Step (3): The authentication executor 114e determines whether the generated set of characters matches the predetermined digit number of characters (for example, numeric characters in the lower three digits of the PIN) in the permission list 165.

The authentication executor 114e determines successful authentication in the case of matching, while determining failed authentication in the case of mismatching. After the authentication, the authentication executor 114e sends back the result of authentication as a return value to the wireless communication setup process and terminates the processing.

According to the first embodiment of the easy authentication process, the images stored in the database 164 are preferably simple pictograms easily recognizable by the user. For the improvement of the user's recognition, the pictograms are preferably simple pictorial expressions of objects belonging to respective categories, for example, everyday items, animals, plants, and foods.

According to the first embodiment of the easy authentication process, the user may enter the character string printed on the ID card CD 1 (for example, the numeric characters in the lower three digits of the PIN) in the text box T71 and press the Send button B72 on the authentication screen W7 (step S810), instead of selection of the images. In this application, the authentication executor 114e may determine whether the received character string matches the character string (for example, the numeric characters in the lower three digits of the PIN) in the permission list 165 in the authentication process at step S814. This expands the option of the input processing and improves the convenience.

As described above, according to the first embodiment of the easy authentication process, the AP 10 (wireless connection device) causes multiple image groups, each consisting of a plurality of images assigned to a plurality of characters by one-to-one correspondence relation in the correspondence list, to be displayed on the PC 20 (client device). In the illustrated example described above, three image groups are displayed correspondingly in the three image selection boxes C71, C72 and C73 on the authentication screen W7. The AP 10 obtains the selection of one image with respect to each of the multiple image groups (C71, C72 and C73) and the specification of the order of the selected images. In other words, only the easy entry is required for the PC 20 to select one image with respect to each of the displayed multiple image groups and specify the order of the selected images. This process causes the PC 20 to specify one image from each of the multiple image groups, thus increasing the flexibility of image selection and increasing the number of options for the small number of image groups. The AP 10 creates a set of characters, such as alphanumeric characters, by using the selected images, the specified order of the images and the correspondence list (one-to-one assignment of images to characters) and authenticates the PC 20 based on the determination whether the created set of characters matches the information in the permission list 165 (permission candidate) stored in advance in the AP 10. More specifically, the AP 10 creates a password of character string from the not-readily-copyable password in the form of images obtained from the PC 20 and authenticates the PC 20 with the created password. The AP 10 used by the PC 20 can thus authenticate the PC 20 by the simple method using a not-readily-copyable password.

Additionally, according to the first embodiment of the easy authentication process, the PC 20 refers to the ID card CD1 (medium including a plurality of images printed next to one another) to specify the information for authentication. This enables the entry using the visual information such as “images” in the PC 20.

### A-5-2. Second Embodiment of Easy Authentication Process

A second embodiment of the easy authentication process differs from the first embodiment by the method of selecting images on the authentication screen and the contents of data transmitted between the AP 10 and the PC 20 for authentication. The following describes only the different configuration and operations from the first embodiment. The configuration parts similar to those of the first embodiment are shown by the like symbols to those of the first embodiment and are not specifically describe here.

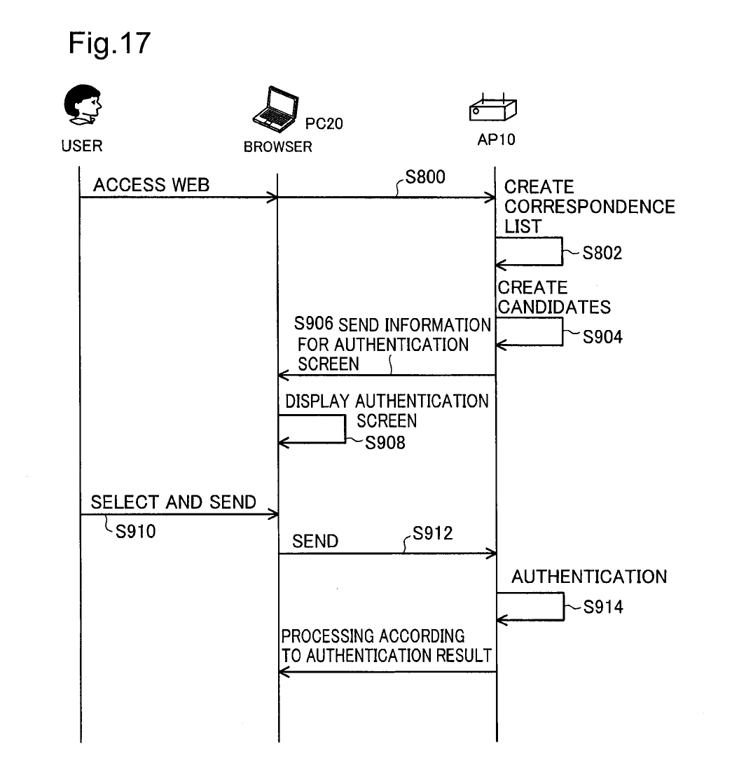

FIG. 17 is a sequence diagram showing the procedure of the second embodiment of the easy authentication process. The processing of steps S800 and S802 is identical with that of the first embodiment shown in FIG. 14. The candidate creator 114c (FIG. 2) of the AP 10 then creates candidates of image sets displayed on the authentication screen (step S904).

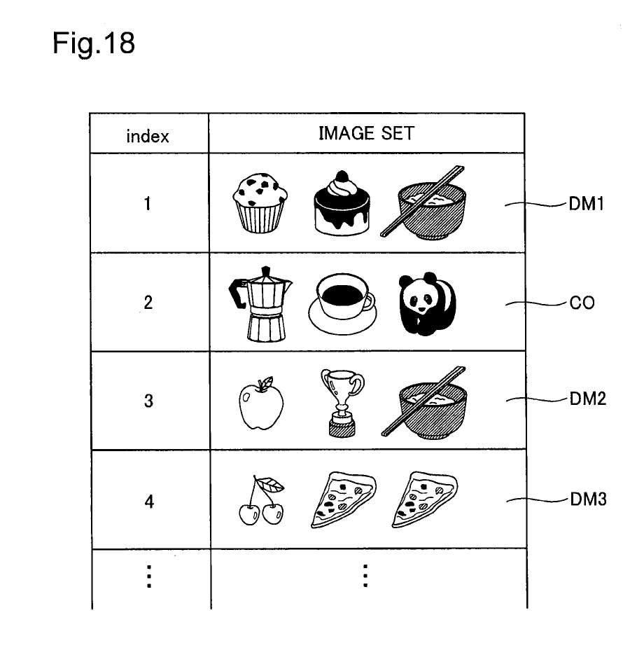

FIG. 18 is a diagram illustrating one example of the candidates created at step S904. The candidates are provided in the form of a table that includes “indexes” as unequivocal identifiers and a plurality of image sets corresponding to the respective “indexes”. The method of creating the candidates is described. The candidate creator 114c assigns an unequivocal identifier at random to an image set CO that is identical with the image P1 printed in the ICON ID field of the ID card CD1. The candidate creator 114c also creates a dummy image set including three images selected at random out of the ten images in the correspondence list and interlinked and assigns an unequivocal identifier to the created dummy image set at random. The candidate creator 114c repeats the process of creating a dummy image set a predetermined number of times to create a plurality of dummy image sets DM1 to DMn.

The guide 117 of the AP 10 generates information for displaying an authentication screen on the WEB browser and sends the generated information to the PC 20 (step S906). According to the embodiment, the information for displaying the authentication screen includes the candidates of image sets. For example, when the candidates shown in FIG. 18 are created, the information for displaying the authentication screen include information of “index=1, image set DM1, index=2, image set CO, index=3, image set DM2, index=4, image set DM3, . . . ”. The guide 117 may encrypt the information for displaying the authentication screen and send the encrypted information, in order to prevent interception from any malicious third person. The processing of step S906 corresponds to the step (a) described in claim 1 of in the claims. The WEB browser of the PC 20 receives the information for displaying the authentication screen and displays the authentication screen (step S908).

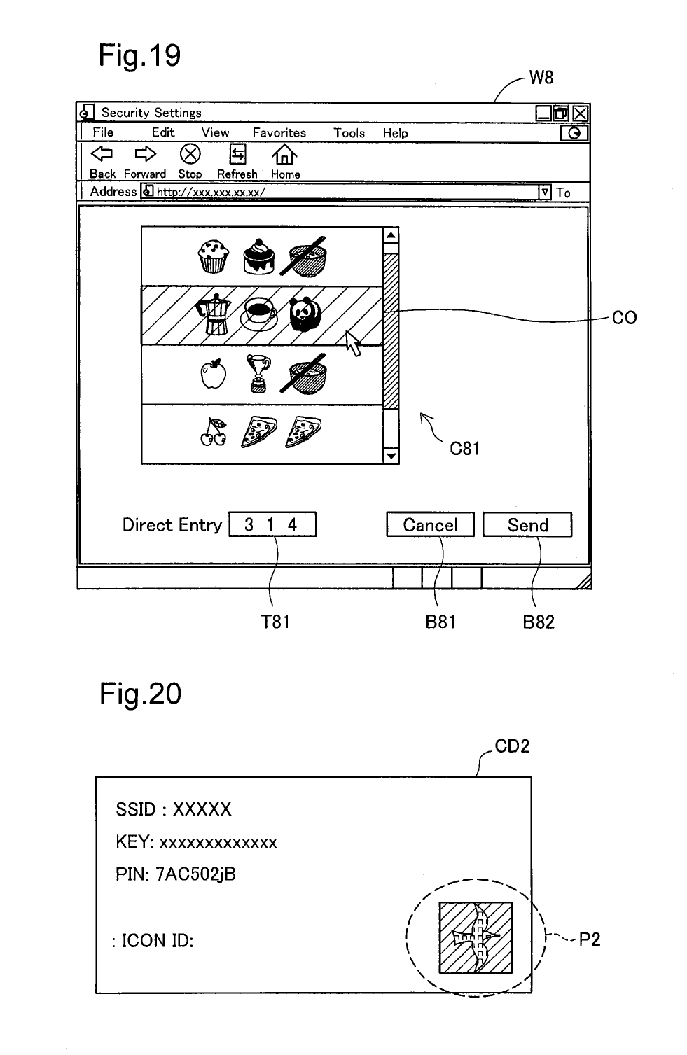

FIG. 19 illustrates one example of the authentication screen displayed on the WEB browser of the PC 20 at step S908. The authentication screen W8 includes an image set selection box C81, a text box T81 for entry of a character string, a Cancel button B81 and a Send button B82. The candidates of image sets (FIG. 18) created at step S904 are displayed in the image set selection box C81 in a selectable manner in the image set unit.

The user selects one image set that is identical with the image P1 printed in the ICON ID field of the ID card CD1 in the image set selection box C81 and presses the Send button B82 (step S910). For example, when the ID card shown in FIG. 13 is distributed to the user, the user selects the image set CO in the image set selection box C81 and presses the Send button B82.

In response to the press of the Send button B82, the WEB browser of the PC 20 sends the index assigned to the image set selected in the image set selection box C81 to the AP 10, and the AP 10 obtains the index (step S912). In the illustrated example of FIG. 13, the information sent from the WEB browser includes the “index=2”.

The authentication executor 114e of the AP 10 performs authentication with the obtained index (step S914). The authentication is performed according to the following steps (1a) to (3a):

Step (1a): The character string creator 114d refers to the candidates created at step S904 and obtains the image set with the assignment of the obtained index.

Step (2a): The character string creator 114d creates a set of characters, based on the image set obtained in the step (1a) and the correspondence list. More specifically, the character string creator 114d extracts the numeric characters assigned to the images of the image set in the correspondence list and replaces the images with the numeric characters to create the “set of characters” as a string of numeric characters.

Step (3a): The authentication executor 114e determines whether the generated set of characters matches the predetermined digit number of characters (for example, numeric characters in the lower three digits of the PIN) in the permission list 165. The details of this step are identical with those of the step (3) of the first embodiment.

As described above, according to the second embodiment of the easy authentication process, the AP 10 (wireless connection device) causes a plurality of image sets, each including a predetermined number of images, (C0, DM1 to DMn) to be displayed on the PC 20 (client device) and receives selection of one image set out of the displayed plurality of image sets. In other words, only the easy entry is required for the PC 20 to simply select one image set out of the plurality of displayed image sets. The AP 10 obtains the index (identifier) assigned to the selected image set, specifies the image set corresponding to the obtained index, creates a set of characters by referring to the correspondence list (one-to-one assignment of images and characters), and performs authentication based on the determination of whether the created set of characters matches the information in the permission list 165 (permission candidate) stored in advance in the AP 10. In other words, the AP 10 obtains the password in the form of the index temporarily assigned to the image set. Even when a malicious third person intercepts an index on the network, the third person cannot use the intercepted index for a subsequent authentication process. This is because a different image set is newly created for the subsequent authentication process and a different index is assigned to the newly created image set. The AP 10 used by the PC 20 can thus authenticate the PC 20 by the simple method using a password that may be copyable but is not continuously usable.

### A-5-3. Third Embodiment of Easy Authentication Process

A third embodiment of the easy authentication process adopts a different method of handling the images used for authentication in the easy authentication process from those of the first embodiment and the second embodiment described above. The third embodiment is applicable as modifications of both the first embodiment and the second embodiment. The following describes only the different configuration and operations from the first embodiment. The configuration parts similar to those of the first embodiment are shown by the like symbols to those of the first embodiment and are not specifically describe here.

FIG. 20 is a diagram illustrating one example of the ID card used for user authentication according to the third embodiment of the easy authentication process. The difference from the first embodiment shown in FIG. 13 is an image P2 displayed in the ICON ID field. The image P2 includes a plurality of images printed in layers, in other words, a plurality of images superimposed one on another. In the illustrated example of FIG. 20, the images of lawn, hatched lines and a seagull are displayed to be superimposed one on another.

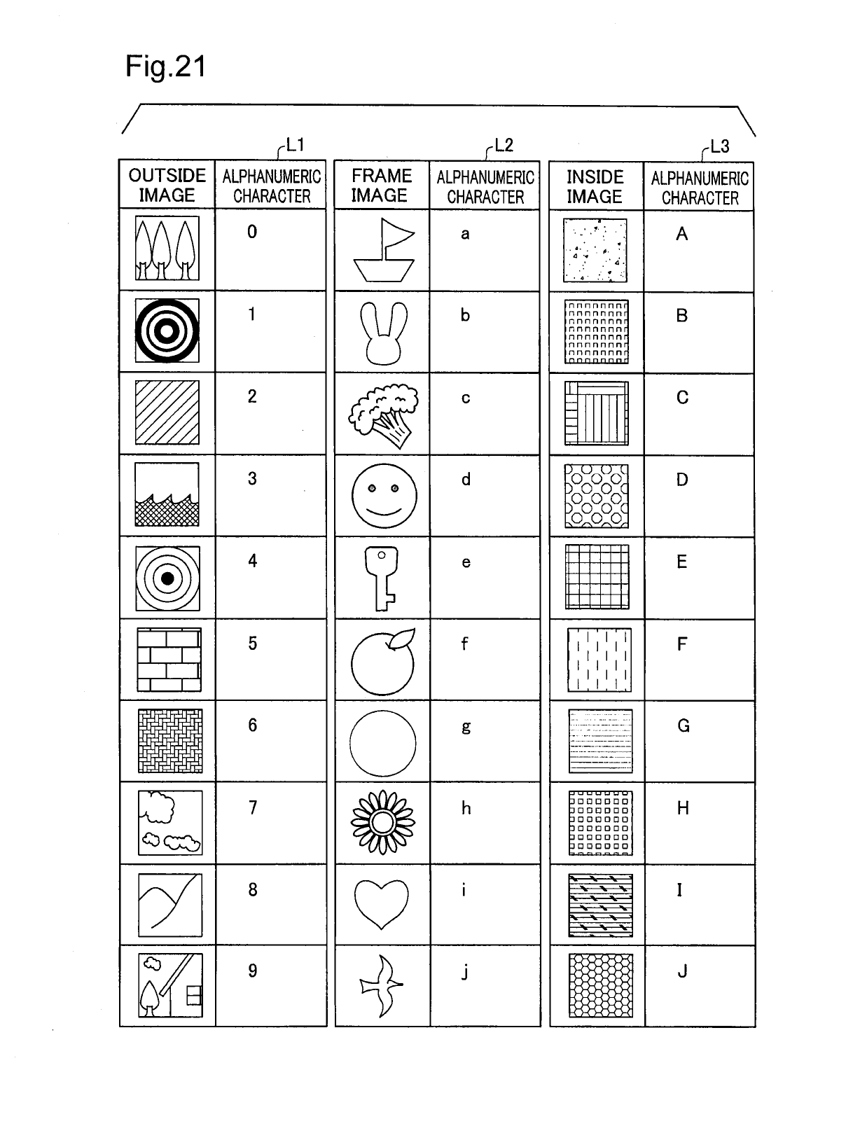

FIG. 21 is a diagram illustrating one example of correspondence lists created at step S802 in the easy authentication process (FIG. 14). According to the third embodiment, the number of correspondence lists created corresponds to the number of the images to be superimposed; namely three correspondence lists are created here. A first correspondence list L1 is a table where each image to be displayed outside of a frame image in the image P2 printed in the ICON ID field (FIG. 20) (hereinafter called “outside image”) is assigned to each character by one-to-one correspondence. A second correspondence list L2 is a table where each image representing the outline to be displayed on the center in the image P2 printed in the ICON ID field (hereinafter called “frame image” or “outline image”) is assigned to each character by one-to-one correspondence. The frame (outline) expressed by the “frame image” may consist of straight lines and/or curved lines. A third correspondence list L3 is a table where each image to be displayed inside of the frame image in the image P2 printed in the ICON ID field (hereinafter called “inside image”) is assigned to each character by one-to-one correspondence. According to the third embodiment, the characters assigned to the images are numeric characters for the first correspondence list L1, alphabetic characters of lower case for the second correspondence list L2 and alphabetic characters of upper case for the third correspondence list L3. These three correspondence lists L1 to L3 specify the correspondence relation between the images and the characters of the respective digits in the character string used for the easy authentication process. Like this embodiment, it is preferable that the respective digits of the character string used for the easy authentication process are expressed by different types of characters.

The correspondence list L1 is created by the following method. The assignor 114a extracts a character string of three digits stored in the permission list 165. In the illustrated example of FIG. 20, “2jB” is extracted. The assignor 114a assigns one specific image identical with the outside image printed in the ICON ID field of the ID card CD2 to the first character of the extracted character string (“2” in the illustrated example of FIG. 20). The assignor 114a then assigns nine outside images selected at random from the database 164 in the flash ROM 160 to the remaining nine numeric characters. The resulting correspondence list L1 has assignment of ten different outside images to ten different numeric characters. The correspondence list L2 is created by the following method. The assignor 114a assigns one specific image identical with the frame image printed in the ICON ID field of the ID card CD2 to the second character of the extracted character string (“j” in the illustrated example of FIG. 20). The assignor 114a then assigns nine frame images selected at random from the database 164 in the flash ROM 160 to the remaining nine alphabetic characters of small case. The resulting correspondence list L2 has assignment of ten different frame images to ten different alphabetic characters of small case. The correspondence list L3 is created in the similar manner. Providing the correspondence list L1 for the first character of the character string used for authentication, the correspondence list L2 for the second character, and the correspondence list L3 for the third character enables the order of the respective images to be readily identified in the ID card CD2 of the third embodiment. When the third embodiment is applied as the modification of the first embodiment, the ten outside images of the correspondence list L1 are displayed in the image selection box C71 on the authentication screen W7 (FIG. 16); the ten frame images of the correspondence list L2 are displayed in the image selection box C72 on the authentication screen W7; and the ten inside images of the correspondence list L3 are displayed in the image selection box C73 on the authentication screen W7.

The main difference of the correspondence lists L1 to L3 of the third embodiment from the first embodiment is that the printed image is a combination of images suitable for superimposition. Each image suitable for superimposition means any of a first type of image (outside image) representing the landscape or the pattern available as a first background, a second type of image (inside image) representing the landscape or the pattern available as a second background and a third type of image (frame image) representing the frame (outline) available as a borderline between the first background and the second background. This improves the user's visual recognition on the individual images of the displayed image in the superimposed manner.

As described above, according to the third embodiment of the easy authentication process, the PC 20 (client device) is notified in advance of the plurality of images P2, which are to be specified for authentication, in the form superimposed one on another by the ID card CD2. This enables the entry using the visual information such as “images” in the PC 20. The superimposed display of the plurality of images reduces the possibility of abuse or fraud even when the details of the notification are leaked to outside by, for example, theft of the ID card CD2.

Additionally, according to the third embodiment of the easy authentication process, each image used for authentication is any of the first type of image available as the first background, the second type of image available as the second background and the third type of image available as the borderline between the first background and the second background. This improves the user's visual recognition on the individual images of the image P2 consisting of the plurality of images displayed in the superimposed manner.

### A-5-4. Fourth Embodiment of Easy Authentication Process

Variations of information used for the authentication in the easy authentication process are described as a fourth embodiment of the easy authentication process. The fourth embodiment is applicable as modifications of all the first to the third embodiments described above. The following describes only the different configuration and operations from the first embodiment. The configuration parts similar to those of the first embodiment are shown by the like symbols to those of the first embodiment and are not specifically describe here.

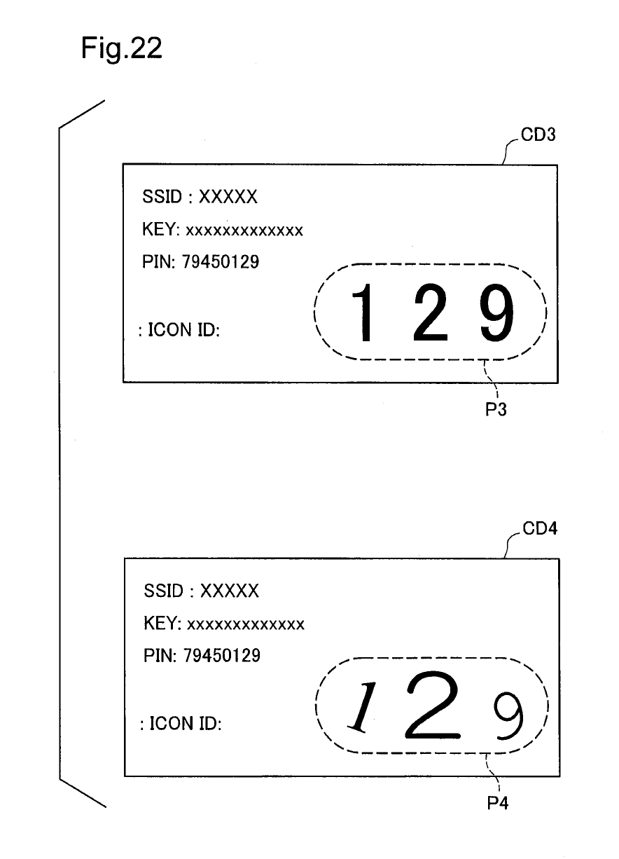

FIG. 22 is diagrams illustrating examples of an ID card used for user authentication according to the fourth embodiment of the easy authentication process. The difference from the first embodiment shown in FIG. 13 is that a character string P3 or P4 is displayed, instead of the image, in the ICON ID field of the ID card CD3 or CD4. The character string P3 or P4 is, for example, numeric characters in the lower three digits of the PIN. The character string P3 includes a plurality of numeric characters in an identical standard font that are printed in an interlinked manner. The character string P4 includes a plurality of numeric characters in different fonts, sizes and displayed angles that are printed in an interlinked manner.

The procedure of the fourth embodiment of the easy authentication process is similar to that of the first embodiment shown in FIG. 14.

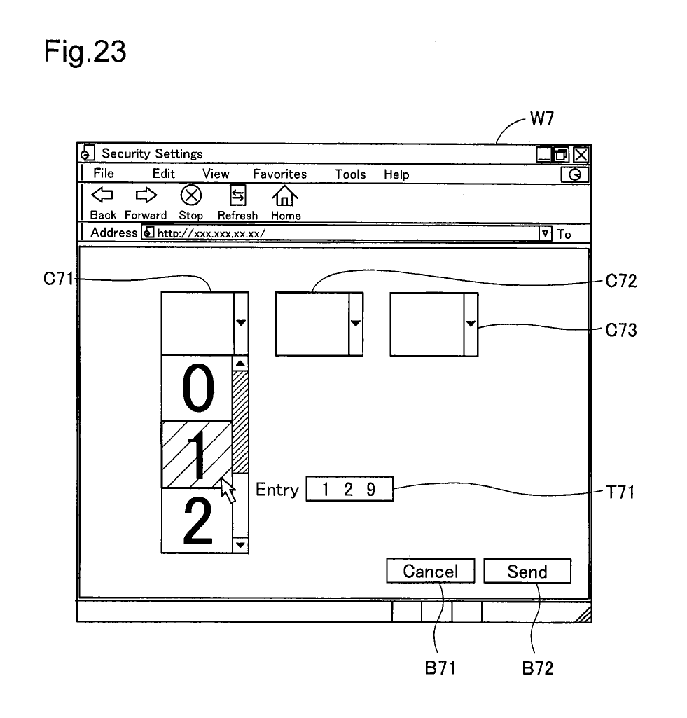

FIG. 23 illustrates one example of the authentication screen displayed on the WEB browser of the PC 20 at step S808 in the easy authentication process (FIG. 14). Refer to the description of the first embodiment for the details. When the user specifies a character string, which is displayed on the ID card shown in FIG. 22, on this authentication screen, authentication is performed.

As described above, the visual expression (graphical part) used for authentication in the easy authentication process may be an image of pictorial expression of an object belonging to at least one of the categories of animals, plants, foods and everyday items used in the first to the third embodiments or may be characters used in the fourth embodiment (e.g., numeric characters, Chinese characters, Japanese syllabary characters (hiragana, katakana), alphabetic characters, Arabic characters, and Latin characters). The image used for authentication in the easy authentication process may include an image of simple pictorial expression belonging to the category of graphics (e.g., circles, triangles and rectangles).

### B. Second Embodiment

A second embodiment of the disclosure adopts a different method for the filtering process performed in the wireless communication setup process. The “filtering process” herein means the process of the AP 10 to discard a packet having a source MAC address that does not match the MAC address obtained at step S112 (FIG. 5). The following describes only the different configuration and operations from the first embodiment. The configuration parts similar to those of the first embodiment are shown by the like symbols to those of the first embodiment and are not specifically describe here.

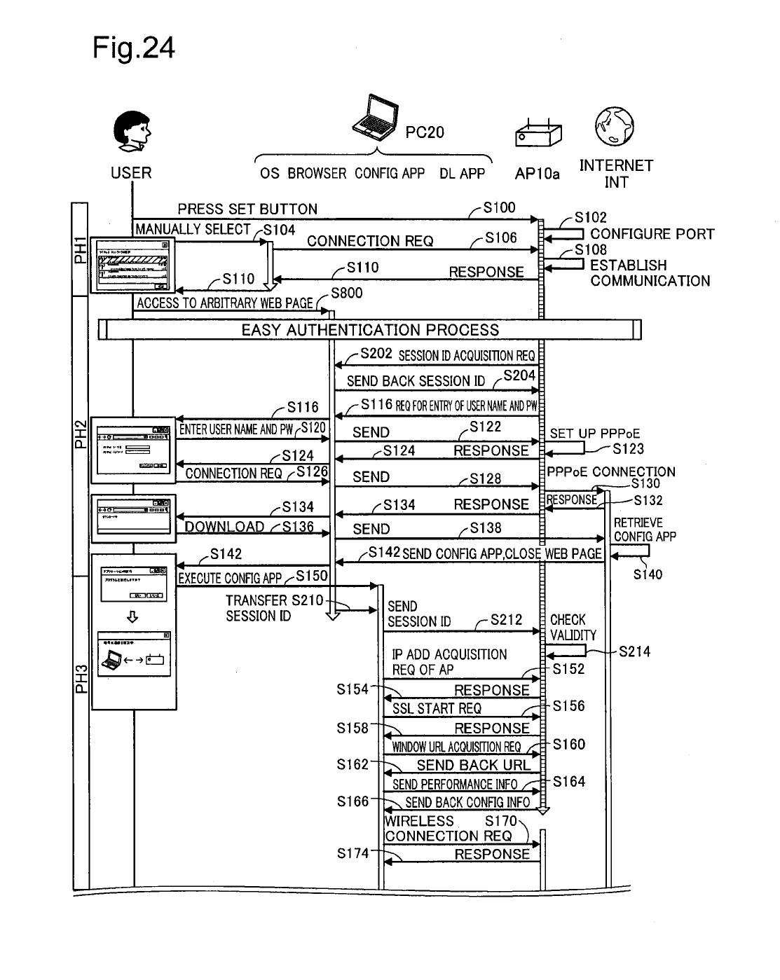

FIG. 24 is a sequence diagram showing the procedure of the wireless communication setup process according to the second embodiment. For the convenience of illustration, the phase PH4 (phase of causing client device to obtain recommended files) is omitted from FIG. 24. The differences from the operations of the first embodiment shown in FIG. 5 are only replacement of steps S202 and S204 for steps S112 and S114 and addition of steps S210 to S214 between steps S150 and S152, and the other operations are identical with those of the first embodiment. The difference in configuration between the AP 10 of the first embodiment (FIG. 2) and an AP 10a of the second embodiment is the operations of the identifier acquirer 115 and the limiter 116. According to the second embodiment, the identifier acquirer 115 obtains a session ID as the identifier assigned to the connection with the client. The limiter 116 limits the communication in the wireless communication setup process by a different method from that of the first embodiment.

When the result of the easy authentication process shows successful authentication, the identifier acquirer 115 of the AP 10a sends a session ID acquisition request to the PC 20 (step S202). When receiving the session ID acquisition request, the browser of the PC 20 generates a session ID and sends back the generated session ID to the AP 10a (step S204). The session ID is not specifically limited but may be any identifier assigned to the management of the connection between the PC 20 and the AP 10a. The session ID may be provided by random number generation and may not be necessarily unequivocal. The identifier acquirer 115 then stores the received session ID into the identifier storage 163.

According to the first embodiment described above, the limiter 116 of the AP performs the filtering process immediately after obtaining the MAC address from the PC. According to the second embodiment, however, the limiter 116 does not perform a limiting process described below before receiving the session ID at step S212.

After execution of the configuration application at step S150, the browser of the PC 20 transfers a specific session ID that is identical with the session ID generated at step S204 to the configuration application (step S210). More specifically, the browser sends a request with a session ID included in query characters to the WEB server activated in the configuration application. When receiving the request, the WEB server extracts the session ID included in the query characters and transfers the extracted session ID to the configuration application. This procedure enables data sharing between the browser and the application, which is generally considered to be difficult.

The configuration application of the PC 20 sends the obtained session ID to the AP 10a (step S212).

After the AP 10a receives the session ID from the configuration application of the PC 20, the limiter 116 of the AP 10a checks the validity of the PC 20 (step S214). More specifically, the limiter 116 determines whether the session ID received from the browser at step S204 matches the session ID received from the configuration application at step S212. In the case of matching of the two session IDs, the limiter 116 judges the PC 20 as the client that has access by the correct procedure and allows continuation of the subsequent processing. In other words, the limiter 116 allows passage of a packet received from the PC 20.

In the case of mismatching of the two session IDs, on the other hand, the limiter 116 judges the PC 20 as the client that has access by the wrong procedure and forcibly disconnects the connection between the PC 20 and the AP 10a. In other words, the limiter 116 prohibits any packet from being received from the PC 20. This process is called “limiting process”. The AP 10a can thus limit the communication by the !ABC connection to the client device confirmed as valid. In other words, the AP 10a can detect and eliminate an access from any malicious third person to the AP 10a by, for example, spoofing the MAC address without the series of operations at steps S800 to S142. This results in improving the security (confidentiality) of the wireless communication setup process.

The second embodiment performs the limiting process using the session ID, in place of the filtering process of the first embodiment using the MAC address. The filtering process of the first embodiment and the limiting process of the second embodiment may be performed in parallel. This further improves the security level of the wireless communication setup process.

The second embodiment generates and obtains the session ID immediately after the easy authentication process. The timing when the AP 10a obtains the session ID from the browser of the PC 20 may be changed arbitrarily as long as the timing is before execution of the configuration application.

According to the second embodiment, the limiter 116 of the AP 10a adopts the method that determines “whether the two session IDs match each other”, in order to check the validity of the PC 20. The limiter 116 may adopt any other method to check the validity using both the session ID received from the browser and the session ID received from the configuration application. For example, the limiter 116 may receive the session ID in the form of a hash value from the configuration application at step S212 and may compare the received session ID (hash value) with the session ID stored in the form of a hash value in the identifier storage 163 to check the validity.

### Modifications

In any of the embodiments described above, part of the hardware configuration may be replaced by the software configuration, and part of the software configuration may be replaced by the hardware configuration. Some examples of possible modifications are given below.

### Modification 1

The above embodiment (FIG. 2) adopts the access point (AP) as the wireless connection device and describes the configuration of the AP. The configuration of the wireless connection device according to the above embodiment is, however, only illustrative, and any other configuration may be adopted. For example, part of the configuration components may be omitted, different configuration components may be added, or part of the configuration components may be changed or modified.

Any of various wirelessly connectable devices may be adopted for the wireless connection device. The wireless connection device may be, for example, a network communication device such as a router, a hub or a modem, a storage device such as an NAS (Network Attached Storage) or an image input/output device such as a digital camera, a printer, a network display or a scanner. The wireless connection device is required to have the wireless connection function but may not necessarily have the packet relay function. It is, however, preferable that the wireless network relay device has both the wireless connection function and the packet relay function.

For example, the Set button is provided in the form of the momentary switch on the AP in the above embodiment but may be replaced by any of various input means that gives an instruction to trigger the wireless communication setup process to the AP. The input means may give an instruction to trigger the wireless communication setup process to the AP, for example, by the user's direct touch, by near field communication from the periphery of the AP or by taking an image of an information code provided by the AP with a built-in camera of the client. The input means may be provided in the form of GUI (Graphical User Interface) when the AP is equipped with a display. The input means may utilize infrared communication or a contact or contactless IC card. The input means may use an information code, such as QR code (registered trademark), barcode or hologram. Any of such input means effectively prevents any malicious third person from giving an instruction to trigger the wireless communication setup process to the AP against the user's intention and thereby prevents leakage of the wireless communication ID information and the encryption information. In order to prevent an unauthorized access from a malicious third person, it is preferable to minimize the coverage that allows an instruction to trigger the wireless communication setup process to be given to the AP. The coverage is, for example, within the area of 10 m from the AP, preferably within the area of 5 m, or more preferably within the area of 1 m. The coverage is most preferably 0 m, which means that the user is required to directly operate the AP to give the start instruction.

According to the above embodiment, the information such as certificate is stored in the flash ROM of the AP. Such information may be stored in the form of tables in any storage medium other than the flash ROM. For example, the AP may be equipped with a USB (Universal Serial Bus) interface, and the respective tables may be stored in a removable portable storage device such as USB memory or USB hard disk.

### Modification 2

The above embodiment (FIG. 4) adopts the personal computer (PC) as the client device and describes the configuration of the PC. The configuration of the client device according to the above embodiment is, however, only illustrative, and any other configuration may be adopted.

Any of various devices other than the PC may be adopted for the client device. The client device may be, for example, any of various types of wireless devices such as an Ethernet (registered trademark) converter, a cell phone, a PDA (Personal Digital Assistant), a game machine, an audio player, a printer and TV set. In a concrete example, a digital camera may be adopted for the PC 20, an NAS (Network Attached Storage) may be adopted for the AP 10a, and data stored in the NAS may be used instead of the data obtained from the server on the Internet. In this example, the respective phases may be configured as described below:

Phase PH1: In wireless connection, the digital camera is connected with the NAS by Ad-hoc connection or WDS connection (or any other IP connection), instead that the client device is connected with the access point by infrastructure connection. The NAS is configured to have DHCP (Dynamic Host Configuration Protocol) server functions. The digital camera obtains an IP address, a default gateway and a DNA (Domain Name System) server address.

Phase PH2: The NAS has an application for the digital camera downloaded in advance and accordingly does not make PPPoE connection. Separately from the processing of the above embodiment, the NAS may obtain data stored in the NAS from the server on the Internet at predetermined intervals and update the data stored in the NAS. The easy authentication process may be modified, such that the NAS is equipped with a touch panel display and that the user selects a desired image among images displayed by the WEB browser of the NAS by the input operation of the touch panel.

Phases PH3 and PH4: identical with those of the above embodiment.

This configuration enables the wireless communication setup process to be performed by not only an information terminal such as a PC or a smartphone but any of other types of wireless devices such as a digital camera. The wireless communication setup process is not limited to the wireless connection by the infrastructure connection but is also applicable to any of various IP connections such as Ad-hoc connection and WDS connection. This modification allows the wireless communication setup process without making connection to the server on the Internet and can thus omit the Internet connection in the wireless communication setup process. The NAS may be replaced with an external hard disk attached to the AP.

Part of the configuration components of the PC shown in FIG. 4 may be omitted, different configuration components may be added, or part of the configuration components may be changed or modified.

### Modification 3

The above embodiment (FIG. 3) describes the configuration of the virtual ports set on the AP (virtual access point). The configuration of the virtual ports according to the above embodiment is, however, only illustrative, and any other configuration may be adopted.

For example, the number of the virtual ports may be determined arbitrarily and may be one or five. The communication settings provided for each of the virtual ports (validity/invalidity of SSID setting, SSID, communication encryption system) are only illustrative, and any other communication settings may be provided.

### Modification 4

The above embodiment (FIGS. 5, 6 and 7) describes the exemplary procedure of the wireless communication setup process. The procedure of the above embodiment is, however, only illustrative and may be modified in any of various ways. Part of the steps may be omitted, different steps may be added, or the execution order of the steps may be changed.

For example, the configuration controller 112 changes the SSID of the virtual port VPA2 at step S102, but this is only illustrative. The configuration controller 112 may change the communication settings of one of the virtual ports to validate the SSID, set the SSID to “!ABC” and change the communication encryption system to “no encryption” or “communication with low encryption level”.

At step S116, the guide 117 may use the default user name and password stored in advance inside the AP to automatically try a PPPoE connection, before requesting the user to enter the PPPoE user name and password. This modification requires the user's entry only in the case of failed connection with the default use name and password, thereby reducing the user's time and effort.

According to the above embodiment, the user's click of the link on the configuration application download screen W3 triggers transmission of a download request at steps S136 and S138. The processing of steps S136 and S138 may, however, be omitted and the download of the configuration application may start automatically.

The SSL protocol is adopted as the predetermined protocol at step S156 and S158 according to the above embodiment, but encrypted communication may be established in conformity with another encryption protocol.

According to the above embodiment, the DL application obtains the list of recommended files and the selected recommended file from the server at steps S186 and S194. The DL application may, however, obtain the list of recommended files and the selected recommended file from the AP instead of the server.

### Modification 5

The above embodiment (FIGS. 8 to 12) describes the exemplary screens displayed on the client in the wireless communication setup process. The screens of the above embodiment are, however, only illustrative and may be modified in any of various ways. Part of the display items may be omitted or different display items may be added.

### Modification 6

The above embodiments (FIGS. 14 and 17) describe the exemplary procedures of the easy authentication process. The procedures of the above embodiments are, however, only illustrative and may be modified in any of various ways. Part of the steps may be omitted, different steps may be added, or the execution order of the steps may be changed.

For example, the easy authentication process of the above embodiment uses the lower three digits of the PIN and the corresponding three images for authentication. The number of the digits of the PIN code and the corresponding number of images used in the easy authentication process may be determined arbitrarily. More specifically, the easy authentication process may use all the digits of the PIN code and the corresponding number of images. The images used in the easy authentication process may not be necessarily related to the PIN.

The easy authentication process of the above embodiment creates the correspondence list at step S802 in every cycle of the processing but may store and reuse the created correspondence list in subsequent cycles of the processing.

According to the above embodiment, the PC sends the images selected in the three image selection boxes in the order of arrangement of these image selection boxes to the AP at step S812. This means that the order of images is not separately specified but follows the order of arrangement of the image selection boxes. The processing of step S812 (and the authentication screen W7) may be modified in any of various ways to select images and specify an order of the selected images. For example, three image selection boxes may be used in combination with a box to specify which ordinal number of images is selected by each image selection box.

### Modification 7

The above embodiments (FIGS. 16 and 19) describe the exemplary screens displayed on the client in the easy authentication process. The screens of the above embodiments are, however, only illustrative and may be modified in any of various ways. Part of the display items may be omitted or different display items may be added.

What is claimed is:

1. A method of authenticating a client device, the method comprising the steps of:
(a) sending, by a wireless connection device, information to the client device indicating an image group to be displayed by the client device, wherein the image group includes a plurality of images each assigned to a respective one of a plurality of characters;
(b) obtaining, by the wireless connection device from the client device, a plurality of images selected from the image group displayed by the client device and a specified order of the plurality of selected images;
(c) creating, by the wireless connection device, a set of characters based on the plurality of selected images, the specified order of the plurality of selected images, and the characters assigned to each of the plurality of selected images; and
(d) authenticating, by the wireless connection device, the client device based on a determination of whether the created set of characters matches information of a permission candidate stored in advance by the wireless connection device.

2. The method according to claim 1, wherein
step (b) includes obtaining the plurality of images selected from the image group displayed by the client device and the specified order of the plurality of selected images based on a printed image including a plurality of images printed next to one another on a medium distributed in advance.

3. The method according to claim 2, wherein
the number of images in the image group include a simple pictorial expression of an object belonging to at least one of categories of graphics, animals, plants, foods and everyday items.

4. The method according to claim 1, wherein
step (b) includes obtaining the plurality of images selected from the image group displayed by the client device and the specified order of the plurality of selected images based on a printed image including a plurality of images printed to be superimposed one on another on a medium distributed in advance.

5. The method according to claim 4, wherein
each image included in the image group is any of a first type of image applicable as a first background, a second type of image applicable as a second background and a third type of image applicable as a borderline between the first background and the second background.

6. The method according to claim 1, wherein
step (c) includes creating the set of characters by the wireless connection device by sorting the plurality of selected images in the specified order of the plurality of selected images and replacing the plurality of sorted images with characters based on the characters assigned to each of the plurality of selected images.

7. The method according to claim 1, wherein
the set of characters is a string of alphanumeric characters.

8. The method according to claim 1, wherein
the wireless connection device is a wireless network relay device that is capable of relaying wireless communication between a plurality of the client devices and the wireless connection device.

9. A wireless connection device, the wireless connection device comprising:
circuitry configured to:
send specific information to a client device indicating an image group to be displayed by the client device, wherein the image group includes a plurality of images each assigned to a respective one of a plurality of characters;
obtain a plurality of images selected out of the image group displayed by the client device and a specified order of the plurality of selected images;
create a set of characters based on the plurality of selected images, the specified order of the plurality of selected images, and the characters assigned to each of the plurality of selected images; and
authenticate the client device based on a determination of whether the created set of characters matches information of a permission candidate stored in advance by the wireless connection device.

10. The wireless connection device according to claim 9, wherein
the circuitry is further configured to obtain the plurality of images selected from the image group displayed by the client device and the specified order of the plurality of selected images based on a printed image including a plurality of images printed next to one another on a medium distributed in advance.

11. The wireless connection device according to claim 10, wherein
the number of images in the image group include a simple pictorial expression of an object belonging to at least one of categories of graphics, animals, plants, foods and everyday items.

12. The wireless connection device according to claim 9, wherein
the circuitry is further configured to obtain the plurality of images selected from the image group displayed on the client device and the specified order of the plurality of selected images based on a printed image including a plurality of images printed to be superimposed one on another on a medium distributed in advance.

13. The wireless connection device according to claim 12, wherein
each image included in the image group is any of a first type of image applicable as a first background, a second type of image applicable as a second background and a third type of image applicable as a borderline between the first background and the second background.

14. The wireless connection device according to claim 9, wherein
the circuitry is further configured to create the set of characters by sorting the plurality of selected images in the specified order of the plurality of selected images and replacing the plurality of sorted images with characters based on the characters assigned to each of the plurality of selected images.

15. The wireless connection device according to claim 9, wherein
the set of characters is a string of alphanumeric characters.

16. The wireless connection device according to claim 9,
the wireless connection device serving as a wireless network relay device that is capable of relaying wireless communication between a plurality of the client devices and the wireless connection device.

17. A method of authenticating a client device, the method comprising the steps of:
(a) creating, by a wireless connection device, a plurality of image sets and assigning an identifier to each of the plurality of image sets, wherein each image set includes a predetermined number of images, and one character is assigned in advance to each of the predetermined number of images;
(b) sending, by the wireless connection device, information to the client device instructing the client device to display the plurality of image sets;
(c) obtaining, by the wireless connection device from the client device, the identifier assigned to one image set selected from the plurality of image sets displayed by the client device;
(d) specifying, by the wireless connection device, the one selected image set by the identifier received from the client device, and creating a set of characters based on the characters assigned in advance to each of the predetermined number of images; and
(e) authenticating, by the wireless connection device, the client device based on a determination of whether the created set of characters matches information of a permission candidate stored in advance by the wireless connection device.

18. The method according to claim 17, wherein
step (c) includes obtaining the identifier assigned to the one image set selected out of the plurality of displayed image sets based on a printed image including a plurality of images printed next to one another on a medium distributed in advance.

19. The method according to claim 18, wherein
the plurality of images included in each of the plurality of image sets include a simple pictorial expression of an object belonging to at least one of categories of graphics, animals, plants, foods and everyday items.

20. The method according to claim 17, wherein
step (c) includes obtaining the identifier assigned to the one image set selected out of the plurality of displayed image sets based on a printed image including a plurality of images printed to be superimposed one on another on a medium distributed in advance.

21. The method according to claim 20, wherein
each of the images included in the plurality of image sets is any of a first type of image applicable as a first background, a second type of image applicable as a second background and a third type of image applicable as a borderline between the first background and the second background.

22. The method according to claim 17, wherein
step (d) includes creating the set of characters by the wireless connection device by specifying the image set based on the obtained identifier and replacing the images included in the specified image set with characters assigned in advance to each of the predetermined number of images.

23. The method according to claim 17, wherein
the set of characters is a string of alphanumeric characters.

24. The method according to claim 17, wherein
the wireless connection device is a wireless network relay device that is capable of relaying wireless communication between a plurality of the client devices and the wireless connection device.

25. A wireless connection device, the wireless connection device comprising:
circuitry configured to:
create a plurality of image sets and assign an identifier to each of the plurality of image sets, wherein each image set includes a predetermined number of images, and one character is assigned in advance to each of the predetermined number of images;
send specific information to the client device, instructing the client device to display the plurality of image sets;
obtain, from the client device, the identifier assigned to one image set selected from the plurality of image sets displayed by the client device;
specify the one selected image set by the obtained identifier and create a set of characters based on the characters assigned in advance to each of the predetermined number of images; and
authenticate the client device, based on a determination of whether the created set of characters matches information of a permission candidate stored in advance by the wireless connection device.

26. The wireless connection device according to claim 25, wherein
the circuitry is further configured to obtain the identifier assigned to the one image set selected out of the plurality of displayed image sets based on a printed image including a plurality of images printed next to one another on a medium distributed in advance.

27. The wireless connection device according to claim 26, wherein
the plurality of images included in each of the plurality of image sets include a simple pictorial expression of an object belonging to at least one of categories of graphics, animals, plants, foods and everyday items.

28. The wireless connection device according to claim 25, wherein
the circuitry is further configured to obtain the identifier assigned to the one image set selected out of the plurality of displayed image sets based on a printed image including a plurality of images printed to be superimposed one on another on a medium distributed in advance.

29. The wireless connection device according to claim 28, wherein
each of the images included in the plurality of image sets is any of a first type of image applicable as a first background, a second type of image applicable as a second background and a third type of image applicable as a borderline between the first background and the second background.

30. The wireless connection device according to claim 25, wherein
the circuitry is further configured to create the set of characters by specifying the image set by the obtained identifier and replacing the images included in the specified image set with characters assigned in advance to each of the predetermined number of images.

31. The wireless connection device according to claim 25, wherein
the set of characters is a string of alphanumeric characters.

32. The wireless connection device according to claim 25,
the wireless connection device serving as a wireless network relay device that is capable of relaying wireless communication between a plurality of the client devices and the wireless connection device.
